(19) United States
(12) Patent Application Publication
(10) Pub. No.: US 2026/0189789 A1
(43) Pub. Date: Jul. 2, 2026

(54) IMAGE DEVICE AND OPERATION METHOD THEREOF

(71) Applicant: SAMSUNG ELECTRONICS CO., LTD., Suwon-si (KR)

(72) Inventors: KYUNG-MIN KIM, Suwon-si (KR); MIN-SUN KEEL, Suwon-si (KR)

(73) Assignee: SAMSUNG ELECTRONICS CO., LTD., Suwon-si (KR)

(21) Appl. No.: 19/254,789

(22) Filed: Jun. 30, 2025

(30) Foreign Application Priority Data
Dec. 30, 2024 (KR) 10-2024-0200233

(51) Int. Cl. H04N 23/68; H04N 23/73; H04N 23/741; H04N 23/745; H04N 25/51; H04N 25/58; H04N 25/78

(52) U.S. Cl. CPC H04N 23/683; H04N 23/6811; H04N 23/73; H04N 23/745; H04N 25/51; H04N 25/78; H04N 23/741; H04N 25/58

(57) ABSTRACT

Disclosed is an image device which includes an image sensor, and an image signal processor. The image sensor includes first pixels generating first analog signals corresponding to a first exposure time and second pixels outputting second analog signals corresponding to a second exposure time shorter than the first exposure time, an analog-to-digital converter that generates first image data by converting the first and second analog signals into a digital signal, and a long-exposure image data generation circuit that generates second image data corresponding to the first exposure time by adjusting pixel values corresponding to the second pixels included in the first image data based on the first exposure time and the second exposure time. The image signal processor includes a short-exposure image data generation circuit generating third image data corresponding to a third exposure time which corresponds to a difference between the first and second exposure times.

### CROSS-REFERENCE TO RELATED APPLICATION

This application claims priority under 35 U.S.C. § 119 to Korean Patent Application No. 10-2024-0200233, filed on Dec. 30, 2024, in the Korean Intellectual Property Office, the disclosure of which is incorporated by reference herein in its entirety.

### BACKGROUND

The present disclosure relates to an image sensor, and more particularly, to an image device and an operation method thereof.

An image sensor obtains image information about an external object by converting a light reflected from the external object into an electrical signal. An electronic device which includes the image sensor may display an image in a display panel by using the obtained image information.

The image sensor may operate based on a long-exposure time for light-emitting diode (LED) flicker mitigation (LFM) and may generate image data. In this case, the motion blur may occur in the image data due to a moving object. Accordingly, there is required an image sensor which generates image data not including the motion blue while alleviating the LED flicker phenomenon.

### SUMMARY

One or more embodiments provide an image device with improved performance and an operation method of the imaging device.

According to an aspect of an embodiment, an image device includes: an image sensor; and an image signal processor. The image sensor includes: a plurality of pixels including first pixels configured to generate first analog signals corresponding to a first exposure time and second pixels configured to output second analog signals corresponding to a second exposure time shorter than the first exposure time; an analog-to-digital converter configured to generate first image data by converting the first and second analog signals into a digital signal; and a long-exposure image data generation circuit configured to generate second image data corresponding to the first exposure time by adjusting pixel values corresponding to the second pixels from among pixel values included in the first image data based on the first exposure time and the second exposure time. The image signal processor includes a short-exposure image data generation circuit configured to generate third image data corresponding to a third exposure time based on the second image data, the third exposure time corresponding to a difference between the first exposure time and the second exposure time.

According to another aspect of an embodiment, an image device includes: an image sensor; and an image signal processor. The image sensor includes: a plurality of pixels including first pixels configured to generate first analog signals corresponding to a first exposure time and second pixels configured to output second analog signals corresponding to a second exposure time shorter than the first exposure time; and an analog-to-digital converter configured to generate first image data by converting the first and second analog signals into a digital signal. The image signal processor includes: a long-exposure image data generation circuit configured to generate second image data corresponding to the first exposure time by adjusting pixel values corresponding to the second pixels from among pixel values included in the first image data based on the first exposure time and the second exposure time; and a short-exposure image data generation circuit configured to generate third image data corresponding to a third exposure time based on pixel values corresponding to the first and second pixels from among the pixel values included in the first image data, the third exposure time corresponding to a difference between the first exposure time and the second exposure time.

According to another aspect of an embodiment, a method of operating an image device which includes an image sensor, and an image signal processor, includes: generating, by the image sensor, first image data corresponding to a first exposure time and a second exposure time shorter than the first exposure time; generating, by the image sensor, second image data by adjusting pixel values of the first image data based on an exposure time adjustment gain, the exposure time adjustment gain corresponding to a value obtained by dividing the first exposure time by the second exposure time; transmitting the second image data to the image signal processor; obtaining, by the image signal processor, the first image data based on the second image data; and generating, by the image signal processor, third image data corresponding to a third exposure time shorter than the second exposure time based on the pixel values of the first image data.

### BRIEF DESCRIPTION OF DRAWINGS

The above and other aspects will be more apparent from the following description of embodiments, taken in conjunction with the accompanying drawings.

FIG. 1 is a diagram illustrating an image device according to an embodiment.

FIG. 2 is a diagram for describing an example of an operation of an image sensor.

FIG. 3 is a block diagram illustrating an image sensor according to an embodiment.

FIGS. 4A and 4B are diagrams for describing a plurality of pixels of a pixel array according to an embodiment.

FIG. 4C is a diagram for describing exposure times according to an embodiment.

FIGS. 5A and 5B are diagrams illustrating one of a plurality of pixels included in a pixel array according to an embodiment.

FIG. 6 is a flowchart for describing an operation method of an image sensor according to an embodiment.

FIG. 7A is a diagram for describing a long-exposure image data generation module according to an embodiment.

FIG. 7B is a diagram for describing an operation method of an image sensor according to an embodiment.

FIG. 8 is a block diagram illustrating an image signal processor according to an embodiment.

FIG. 9A is a block diagram illustrating a short-exposure image data generation module according to an embodiment.

FIG. 9B is a flowchart for describing an operation method of an image signal processor according to an embodiment.

FIG. 10 is a diagram for describing an operation method of an image signal processor according to an embodiment.

FIGS. 11A, 11B and 11C are diagrams for describing an operation method of an image signal processor according to an embodiment.

FIG. 12 is a diagram for describing an operation method of an image signal processor according to an embodiment.

FIG. 13 is a diagram for describing a plurality of pixels of a pixel array according to an embodiment.

FIG. 14 is a diagram for describing mixed image data and long-exposure image data generated by an image sensor including a pixel array according to an embodiment.

FIGS. 15A, 15B and 15C are diagrams for describing an operation method of an image signal processor according to an embodiment.

FIG. 16 is a block diagram for describing an image signal processor according to an embodiment.

FIG. 17A is a block diagram for describing a combined image data generation module according to an embodiment.

FIG. 17B is a flowchart for describing an operation method of an image signal processor according to an embodiment.

FIG. 17C is a diagram for describing an operation method of an image signal processor according to an embodiment.

FIGS. 18A and 18B are diagrams for describing an image device according to embodiments.

FIG. 19 is a block diagram of an electronic device including a multi-camera module according to an embodiment.

FIG. 20 is a block diagram illustrating a camera module according to an embodiment.

FIG. 21 is a diagram illustrating an autonomous driving system according to an embodiment.

### DETAILED DESCRIPTION

Below, embodiments will be described with reference to the accompanying drawings Embodiments described herein are provided as examples, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

In the specification, function blocks of drawings, which respectively correspond to the terms “block”, “unit”, “logic”, etc., may be implemented in hardware, which may operate according to computer instructions.

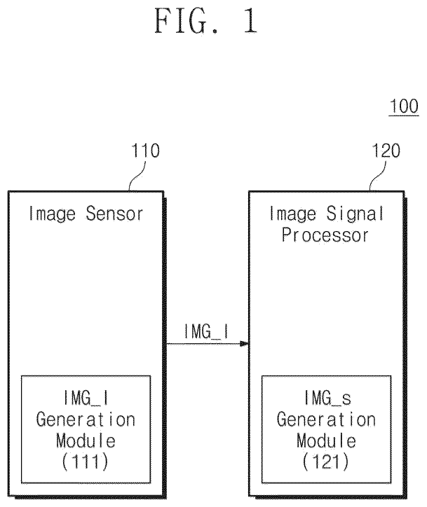

FIG. 1 is a diagram illustrating an image device according to an embodiment. Referring to FIG. 1, an image device 100 may include an image sensor 110 and an image signal processor 120. In an embodiment, the image device 100 may be implemented as a part of various electronic devices such as a camera, a smartphone, a wearable device, an Internet of Things (IoT) device, home appliances, a tablet personal computer (PC), a personal digital assistant (PDA), a portable multimedia player (PMP), a navigation system, a drone, an advanced drivers assistance system (ADAS), a traffic camera, and a CCTV. Also, the image device 100 may be mounted on an electronic device which is provided as a part of a vehicle, furniture, manufacturing equipment, a door, and various kinds of measuring instruments.

The image sensor 110 may output image data based on a light incident from the outside. For example, the image sensor 110 may include a plurality of pixels. Each of the plurality of pixels may be configured to output an electrical signal corresponding to the light incident from the outside. The image sensor 110 may output the image data based on the electrical signal. In an embodiment, a long-exposure time may be applied to some of the plurality of pixels of the image sensor 110, and a medium-exposure time may be applied to the others thereof. According to the above description, the image sensor 110 may generate mixed image data including pixel values corresponding to the long-exposure time and pixel values corresponding to the medium-exposure time.

In an embodiment, the image sensor 110 may include a long-exposure image data generation module (e.g., long-exposure image data generation circuit) 111. The long-exposure image data generation module 111 may adjust the pixel values of the mixed image data to generate long-exposure image data IMG_l corresponding to the long-exposure time.

The image signal processor 120 may receive the long-exposure image data IMG_l from the image sensor 110 and may perform various signal processing operations on the received long-exposure image data IMG_l. For example, the image signal processor 120 may perform the following signal processing on the received long-exposure image data IMG_l: noise reduction, white balancing, gamma correction, color correction, and color transformation. The signal-processed image data may be transmitted to an external device (e.g., a display device) or may be stored in a separate storage device.

In an embodiment, the image signal processor 120 may include a short-exposure image data generation module (e.g., short-exposure image data generation circuit) 121. The short-exposure image data generation module 121 may obtain the mixed image data by adjusting the pixel values of the long-exposure image data IMG_l. The short-exposure image data generation module 121 may generate short-exposure image data based on the mixed image data. In an embodiment, the short-exposure image data may correspond to a short-exposure time indicating a difference between the long-exposure time and the medium-exposure time.

For example, the long-exposure time may be a time longer than the reciprocal of a period at which a light-emitting diode (LED) signal flickers. Accordingly, the long-exposure image data IMG_l may be image data in which the LED flicker phenomenon is alleviated. The long-exposure image data IMG_l may include at least one blur region. The blur region may indicate a region in which the motion blur occurs due to the movement of an object targeted for photographing of the image device 100 during the long-exposure time. Because the short-exposure image data are image data generated based on the short-exposure time, the short-exposure image data may be image data in which the motion blur is alleviated.

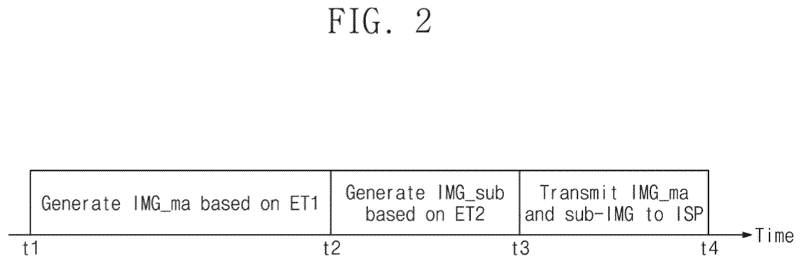

FIG. 2 is a diagram for describing an example of an operation of an image sensor of FIG. 1. In FIG. 2, it is assumed that the image sensor 110 does not include the long-exposure image data generation module 111. Referring to FIGS. 1 and 2, during a time period from t1 to t2, the image sensor 110 may generate main image data IMG_ma based on a first exposure time ET1. In detail, the image sensor 110 may apply the first exposure time ET1 to all the pixels to generate the main image data IMG_ma. For example, the length of the first exposure time ET1 may be identical to the length of the long-exposure time. According to the above description, the main image data IMG_ma may be a signal in which the LED flicker phenomenon is alleviated.

The main image data IMG_ma may be data generated by capturing an object moving during the first exposure time ET1. Accordingly, the main image data IMG_ma may be image data including the blur region in which the motion blur occurs. Due to the blur region, the image device 100 may fail to accurately recognize information about the moving object based on the main image data IMG_ma. For example, the information about the moving object may include information about a kind of an object, a shape of an object, a text included in a moving object, etc.

Accordingly, during a time period from t2 to t3, the image sensor 110 may generate sub-image data IMG_sub based on a second exposure time ET2. In detail, the image sensor 110 may apply the second exposure time ET2 to all the pixels to generate the sub-image data IMG_sub. For example, the length of the second exposure time ET2 may be identical to the length of the short-exposure time. The length of the first exposure time ET1 may be longer than the length of the second exposure time ET2. The sub-image data IMG_sub may be image data in which the motion blur is alleviated. For example, the image device 100 may obtain information about the moving object based on the sub-image data IMG_sub.

During a time period from t3 to t4, the image sensor 110 may transmit the main image data IMG_ma and the sub-image data IMG_sub to the image signal processor 120.

As described above, according to the example of FIG. 2, after generating the main image data IMG_ma, the sub-image data IMG_sub may be generated through an additional readout operation. In this case, the operation speed of the image sensor 110 may slow due to the additional readout operation for generating the sub-image data IMG_sub.

Also, the main image data IMG_ma and the sub-image data IMG_sub may be generated based on lights incident at the different time points. That is, the main image data IMG_ma may be data generated based on the light incident onto the pixels of the image sensor 110 during the first exposure time ET1 from the first time point t1, and the sub-image data IMG_sub may be data generated based on the light incident onto the pixels of the image sensor 110 during the second exposure time ET2 from the second time point t2. In this case, due to the moving object, an object corresponding to the blur region of the main image data IMG_ma may not be placed at a position of the sub-image data IMG_sub, which corresponds to the blur region of the main image data IMG_ma. This may mean that the image device 100 fails to obtain information about the object corresponding to the blur region of the main image data IMG_ma based on the sub-image data IMG_sub.

Also, because the image sensor 110 transmits both the main image data IMG_ma and the sub-image data IMG_sub to the image signal processor 120, the output data throughput of the image sensor 110 may increase. This may mean that the data processing speed of the image device 100 slows.

Unlike the example described with reference to FIG. 2, the image sensor 110 according to an embodiment may generate the mixed image data by applying the long-exposure time to some pixels and applying the medium-exposure time to the other pixels. The image sensor 110 may adjust the pixel values of the mixed image data to generate the long-exposure image data IMG_l. That is, the image sensor 110 according to an embodiment may not perform the additional readout operation for generating the sub-image data IMG_sub. According to the above description, the operation speed of the image device 100 may increase.

Also, the image sensor 110 may transmit only the long-exposure image data IMG_l to the image signal processor 120. According to the above description, the output data throughput of the image sensor 110 may decrease compared to the image sensor operating as described with reference to the example of FIG. 2. Accordingly, the data processing speed of the image device 100 may increase.

The image signal processor 120 according to an embodiment may obtain the mixed image data from the long-exposure image data IMG_l. For example, the image signal processor 120 may adjust the pixel values of the long-exposure image data IMG_l to obtain the mixed image data. The image signal processor 120 may generate the short-exposure image data based on the mixed image data. A short-exposure image data IMG_s may correspond to the short-exposure time. Also, the short-exposure image data IMG_s may correspond to data generated based on the light incident onto the image sensor 110 from the same time point as the long-exposure image data IMG_l. Accordingly, compared to the image sensor operating as described with reference to the example of FIG. 2, the image signal processor 120 may obtain accurate information about the moving object based on the short-exposure image data IMG_s.

An operation of the image device 100 according to an embodiment will be described in detail with reference to the following drawings.

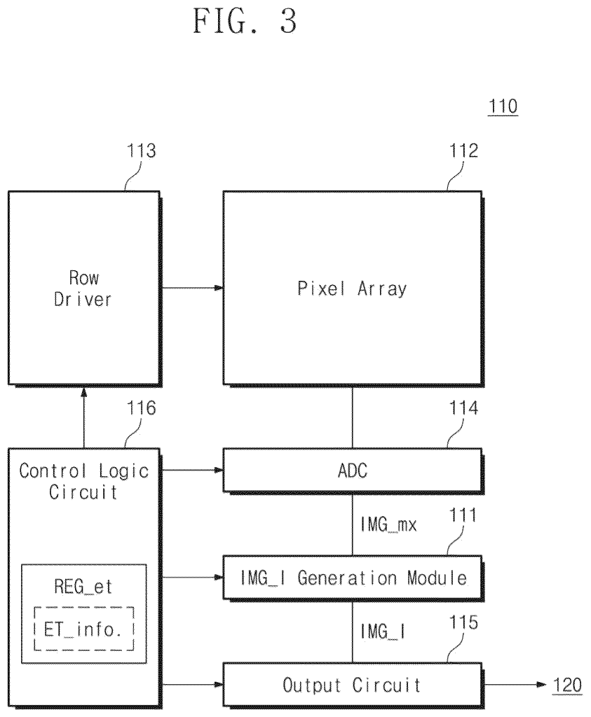

FIG. 3 is a block diagram illustrating an example of an image sensor of FIG. 1. Referring to FIGS. 1 and 3, the image sensor 110 may include the long-exposure image data generation module 111, a pixel array 112, a row driver (e.g., row driver circuit) 113, an analog-to-digital converter (ADC) (e.g., ADC circuit) 114, an output circuit 115, and a control logic circuit 116.

The pixel array 112 may include a plurality of pixels. Each of the plurality of pixels may be configured to output an electrical signal, which is proportional to the intensity of light incident from the outside, that is, an analog signal based on the incident light. In an embodiment, to receive lights of different wavelengths, the plurality of pixels may be combined with different color filters (e.g., R, G, and B color filters). In an embodiment, the color filters combined with the plurality of pixels may form a color filter array (CFA) of a specific pattern. The color filter array may be formed based on at least one of various patterns such as a Bayer pattern and a tetra pattern.

In an embodiment, the plurality of pixels may include first pixels configured to output first analog signals based on the long-exposure time. Also, the plurality of pixels may include second pixels configured to output second analog signals based on the medium-exposure time.

The row driver 113 may be configured to control the plurality of pixels included in the pixel array 112. For example, the row driver 113 may generate various control signals (e.g., a transfer signal, a reset signal, and a selection signal) for controlling the plurality of pixels. In an embodiment, the row driver 113 may control the plurality of pixels in units of row, but embodiments are not limited thereto. In an embodiment, the row driver 113 may adjust an exposure time of the plurality of pixels based on exposure time stored in an exposure time register REG_et of the control logic circuit 116.

The ADC 114 may convert the analog signals (e.g., the first and second analog signals) generated from the plurality of pixels into digital signals and may output the converted digital signals as mixed image data IMG_mx. In an embodiment, the ADC 114 may generate the mixed image data IMG_mx based on correlated double sampling (CDS). The image sensor 110 may further include a storage circuit or a memory configured to store the mixed image data IMG_mx output from the ADC 114 and a ramp signal generator configured to generate a ramp signal used for the operation of the ADC 114. The mixed image data IMG_mx may indicate (e.g., include) pixel values corresponding to the long-exposure time (e.g., pixel values corresponding to the first pixels) and pixel values corresponding to the medium-exposure time (e.g., pixel values corresponding to the second pixels).

The long-exposure image data generation module 111 may generate the long-exposure image data IMG_l based on the mixed image data IMG_mx provided from the ADC 114. For example, the long-exposure image data generation module 111 may generate the long-exposure image data IMG_l by adjusting the pixel values of the mixed image data IMG_mx, which correspond to the medium-exposure time.

The output circuit 115 may transmit the long-exposure image data IMG_l output from the long-exposure image data generation module 111 to the image signal processor 120.

The control logic circuit 116 may be configured to control various components in the image sensor 110 under control of an external control device (e.g., an image sensor device controller). In an embodiment, the control logic circuit 116 may include the exposure time register REG_et. The exposure time register REG_et may store exposure time information ET_info. The exposure time information ET_info. may include information about the long-exposure time and the medium-exposure time. In an embodiment, the control logic circuit 116 may receive the exposure time information ET_info. from the image signal processor 120. The control logic circuit 116 may store the received exposure time information ET_info. in the exposure time register REG_et. The control logic circuit 116 may control the row driver 113 based on the exposure time information ET_info. such that an exposure time to be applied to the pixels of the pixel array 112 is controlled.

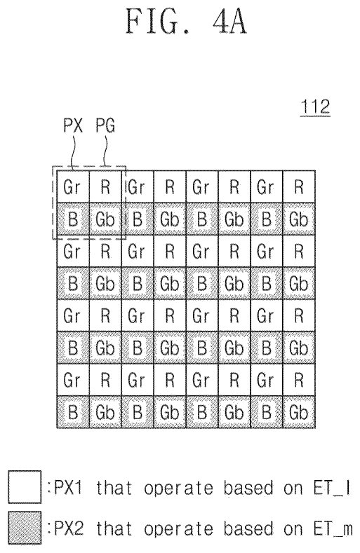

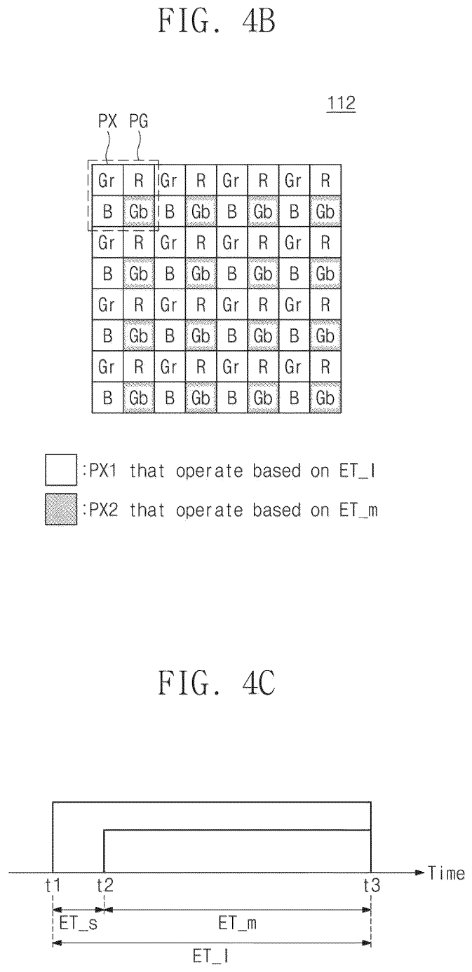

FIGS. 4A and 4B are diagrams for describing a plurality of pixels of a pixel array of FIG. 3. FIG. 4C is a diagram for describing exposure times of FIG. 2, which are applied to pixels. Referring to FIGS. 1, 3, and 4A, the pixel array 112 of the image sensor 110 may include a plurality of pixel groups PG. The plurality of pixel groups PG may be arranged along a row direction and a column direction. Each of the plurality of pixel groups PG may include a plurality of pixels PX.

Each of the plurality of pixels PX may be configured to output an electrical signal corresponding to an incident light under control of the row driver 113. The plurality of pixels PX may respectively correspond to color filters R, Gr, B, and Gb for receiving lights of specific wavelengths. That is, the pixels PX corresponding to a first color filter (e.g., Gr) may receive a light of a green color, the pixels PX corresponding to a second color filter (e.g., R) may receive a light of a red color, the pixels PX corresponding to a third color filter (e.g., B) may receive a light of a blue color, and the pixels PX corresponding to a fourth color filter (e.g., Gb) may receive a light of a green color. Kinds and the arrangement of the color filters are provided as an example, and embodiments are not limited thereto. For example, each of the plurality of pixel groups PG may include four pixels PX which respectively correspond to the color filters R, Gr, B, and Gb.

The plurality of pixels PX may include first pixels PX1 and second pixels PX2. A long-exposure time ET_l may be applied to the first pixels PX1, and a medium-exposure time ET_m may be applied to the second pixels PX2.

For example, as illustrated in FIG. 4A, pixels PX belonging to odd-numbered rows among a plurality of rows of the pixel array 112 may be the first pixels PX1 to which the long-exposure time ET_l is applied. Pixels PX belonging to even-numbered rows among the plurality of rows of the pixel array 112 may be the second pixels PX2 to which the medium-exposure time ET_m is applied.

Alternatively, as illustrated in FIG. 4B, the pixels PX corresponding to the fourth color filter (e.g., Gb) from among the pixels PX of the pixel array 112 may be the second pixels PX2 to which the medium-exposure time ET_m is applied, and the remaining pixels PX may be the first pixels PX1 to which the long-exposure time ET_l is applied.

However, embodiments are not limited thereto. For example, exposure times to which the pixels PX are applied may be variously changed.

As illustrated in FIG. 4C, the first pixel PX1 to which the long-exposure time ET_l is applied may generate an electrical signal corresponding to a first light received during a time period from t1 to t3, the second pixel PX2 to which the medium-exposure time ET_m is applied may generate an electrical signal corresponding to a second light received during a time period from t2 to t3, and the pixel PX to which a short-exposure time ET_s is applied may generate an electrical signal corresponding to a third light received during a time period from t1 to t2. That is, in the same luminance environment, the magnitude of the electrical signal output from the pixel PX (i.e., the first pixel PX1) to which the long-exposure time ET_l is applied may be greater than the electrical signal output from the pixel PX to which the medium-exposure time ET_m or the short-exposure time ET_s is applied.

In an embodiment, the length of the short-exposure time ET_s may mean a difference between the long-exposure time ET_l and the medium-exposure time ET_m.

As described above, as different exposure times are applied to the plurality of pixels PX, the mixed image data IMG_mx corresponding to two exposure times (e.g., the long-exposure time ET_l and the medium-exposure time ET_m) may be obtained.

In an embodiment, to generate high dynamic range (HDR) image data, some of the pixels PX of the pixel array 112 may operate in a high conversion mode (HCG) mode, and the others thereof may operate in a low conversion gain (LCG) mode. In this case, the image sensor 110 may apply a first long-exposure time to some of the first pixels PX1 (e.g., the first pixels PX1 operating in the HCG mode) and may apply a first medium-exposure time to some of the second pixels PX2 (e.g., the second pixels PX2 operating in the HCG mode), Also, the image sensor 110 may apply a second long-exposure time to some of the first pixels PX1 (e.g., the first pixels PX1 operating in the LCG mode) and may apply a second medium-exposure time to some of the second pixels PX2 (e.g., the second pixels PX2 operating in the LCG mode), In this case, for example, the length of the first long-exposure time may be shorter than the length of the second long-exposure time, and the length of the first medium-exposure time may be shorter than the length of the second medium-exposure time. According to the above description, the image sensor 110 may generate the mixed image data IMG_mx based on a plurality of long-exposure times and a plurality of short-exposure times.

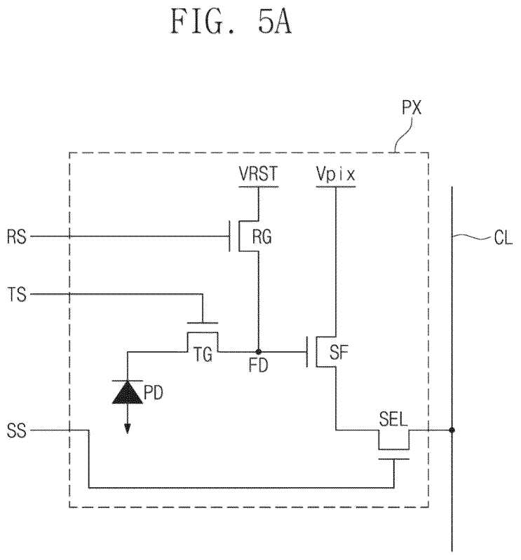

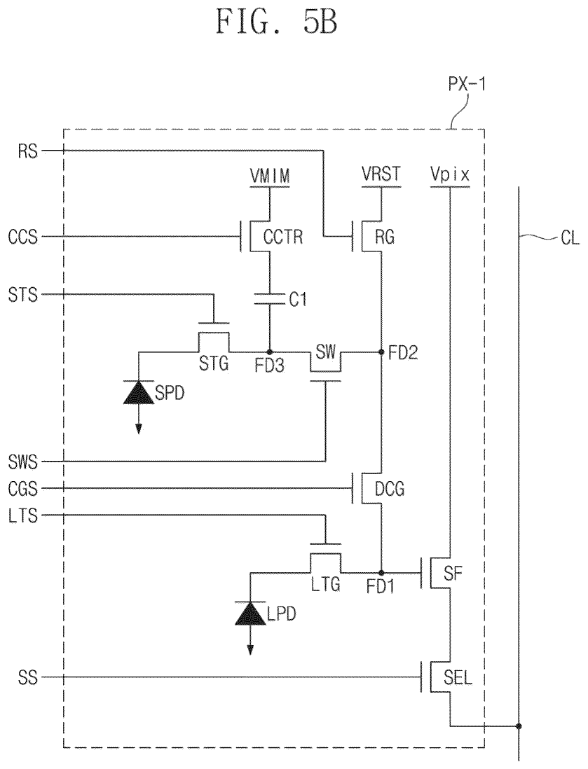

FIGS. 5A and 5B are diagrams illustrating an example of one of a plurality of pixels included in a pixel array of FIG. 3.

Referring to FIGS. 3 and 5A, the pixel PX may include a photodiode PD, a transfer transistor TG, a reset transistor RG, a source follower transistor SF, and a selection transistor SEL.

The photodiode PD may be configured to generate charges corresponding to the intensity of light incident from the outside. The transfer transistor TG may be connected between the photodiode PD and a floating diffusion region FD. The transfer transistor TG may transfer the charges generated by the photodiode PD to the floating diffusion region FD in response to a transfer signal TS. The reset transistor RG may be connected between a reset voltage VRST and the floating diffusion region FD. The reset transistor RG may reset the floating diffusion region FD with the reset voltage VRST in response to a reset signal RS. The source follower transistor SF may be connected between a power supply voltage Vpix and the selection transistor SEL. The source follower transistor SF may operate in response to the level of the floating diffusion region FD. The selection transistor SEL may be connected between the source follower transistor SF and a column line CL. The selection transistor SEL may operate in response to a selection signal SS.

In an embodiment, the control signals generated by the row driver 113 described with reference to FIG. 3 may include the reset signal RS, the transfer signal TS, and the selection signal SS described with reference to FIG. 5A. However, embodiments are not limited thereto. For example, the control signals may be variously changed and modified depending on the structure of the pixel.

The first pixel PX1 of FIGS. 4A and 4B may be configured to output, through the column line CL, a first analog signal corresponding to a light incident onto the photodiode PD during the long-exposure time ET_l, and the second pixel PX2 may be configured to output, through the column line CL, a second analog signal corresponding to a light incident onto the photodiode PD during the medium-exposure time ET_m.

Referring to FIG. 5B, the plurality of pixels PX may have a split photodiode structure. For example, as illustrated in FIG. 5B, one pixel PX-1 may include a large photodiode LPD, a small photodiode SPD, a large transfer transistor LTG, a source follower transistor SF, a selection transistor SEL, a dual conversion gain transistor DCG, a reset transistor RG, a switch SW, a capacitor control transistor CCTR, a small transfer transistor STG, and a first capacitor C1.

The large transfer transistor LTG may be connected between the large photodiode LPD and a first floating diffusion region FD1, and may operate in response to a large transfer signal LTS. The source follower transistor SF may be connected between the power supply voltage VPIX and the selection transistor SEL, and may operate in response to the level of the first floating diffusion region FD1.

The dual conversion gain transistor DCG may be connected between the first floating diffusion region FD1 and a second floating diffusion region FD2, and may operate in response to a gain control signal CGS. The reset transistor RG may be connected between the reset voltage VRST and the second floating diffusion region FD2, and may operate in response to the reset signal RS.

The switch SW may be connected between the second floating diffusion region FD2 and a third floating diffusion region FD3, and may operate in response to a switching signal SWS. The small transfer transistor STG may be connected between the small photodiode SPD and the third floating diffusion region FD3, and may operate in response to a small transfer signal STS.

The first capacitor C1 may be connected between the capacitor control transistor CCTR and the third floating diffusion region FD3. The capacitor control transistor CCTR may be connected between the first capacitor C1 and a capacitor power supply voltage VMIM, and may operate in response to a capacitor control signal CCS.

In an embodiment, the large photodiode LPD and the small photodiode SPD may generate charges based on the light incident from the outside. The large photodiode LPD has a wider light reception area than the small photodiode SPD. That is, when the same light is incident, the large photodiode LPD may be quickly saturated compared to the small photodiode SPD. Accordingly, the large photodiode LPD may generate effective image information in a low-illuminance environment, and the small photodiode SPD may generate effective image information in a high-illuminance environment.

The large photodiode LPD and the small photodiode SPD may selectively operate depending on ambient illuminance of an object. For example, the large photodiode LPD may operate to generate a pixel signal in the low-luminance environment, and the small photodiode SPD may operate to generate a pixel signal in the high-illuminance environment. As the images obtained from the large photodiode LPD and the small photodiode SPD are merged, the dynamic range of the image sensor 110 may be improved (i.e., the HDR may be implemented).

In an embodiment, the pixel PX-1 may support a dual conversion gain mode. For example, the large photodiode LPD and the small photodiode SPD of the pixel PX-1 may respectively operate in the high conversion gain mode or the low conversion gain mode. The high conversion gain mode may be advantageous in the low-illuminance environment, and the low conversion gain mode may be advantageous in the high-illuminance environment. Accordingly, as the large photodiode LPD and the small photodiode SPD operate in the high conversion gain mode or the low conversion gain mode, the dynamic range of the image sensor 110 may be improved (i.e., the HDR may be implemented).

In an embodiment, various row control signals (e.g., STS, LTS, SWS, RS, CGS, CCS, and SS) for driving the pixel PX-1 may be driven or controlled by the row driver 113.

In an embodiment, the pixels of FIGS. 4A and 4B may be implemented in the structure of the pixel PX-1 illustrated in FIG. 5B. In this case, the first pixel PX1 may be configured to output, through the column line CL, a first analog signal corresponding to a light incident onto the large photodiode LPD and the small photodiode SPD (or one of the large photodiode LPD and the small photodiode SPD) during the long-exposure time ET_l, and the second pixel PX2 may be configured to output, through the column line CL, a second analog signal corresponding to a light incident onto the large photodiode LPD and the small photodiode SPD (or one of the large photodiode LPD and the small photodiode SPD) during the medium-exposure time ET_m.

The pixel structure described with reference to FIGS. 5A and 5B is provided as an example, and embodiments are not limited thereto. For example, the pixel may be implemented based on various pixel structures such as a 4-photodiode structure and a shared pixel structure.

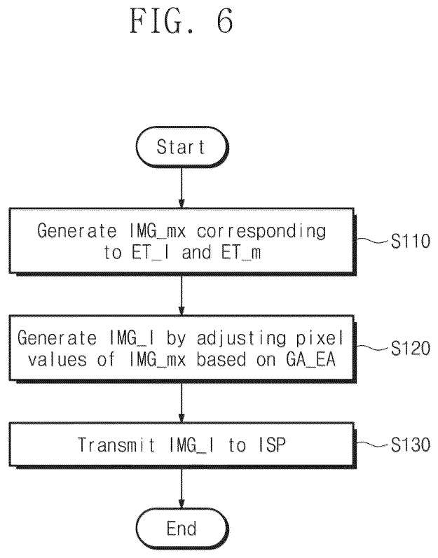

FIG. 6 is a flowchart for describing an operation method of an image sensor of FIG. 3. Referring to FIGS. 1, 3 to 4C, and 6, in operation S110, the image sensor 110 may generate the mixed image data IMG_mx based on the long-exposure time ET_l and the medium-exposure time ET_m. In detail, the image sensor 110 may generate the mixed image data IMG_mx by applying the long-exposure time ET_l to the first pixels PX1 of the pixel array 112 and applying the medium-exposure time ET_m to the second pixels PX2 of the pixel array 112.

In operation S120, the image sensor 110 may generate the long-exposure image data IMG_l by adjusting the pixel values of the mixed image data IMG_mx based on an exposure time adjustment gain GA_EA. For example, the long-exposure image data generation module 111 may calculate the exposure time adjustment gain GA_EA based on the exposure time information ET_info. The long-exposure image data generation module 111 may generate the long-exposure image data IMG_l by multiplying the exposure time adjustment gain GA_EA and pixel values corresponding to the second pixels PX2 from among the pixel values of the mixed image data IMG_mx together.

In operation S130, the image sensor 110 may transmit the long-exposure image data IMG_l to the image signal processor 120.

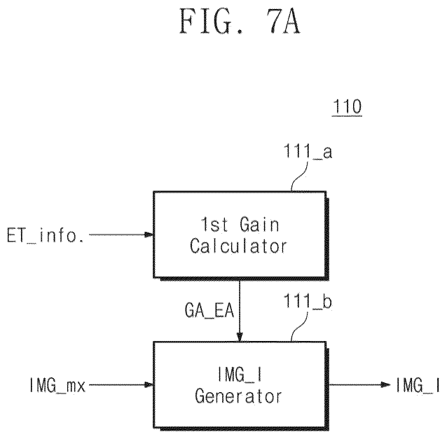

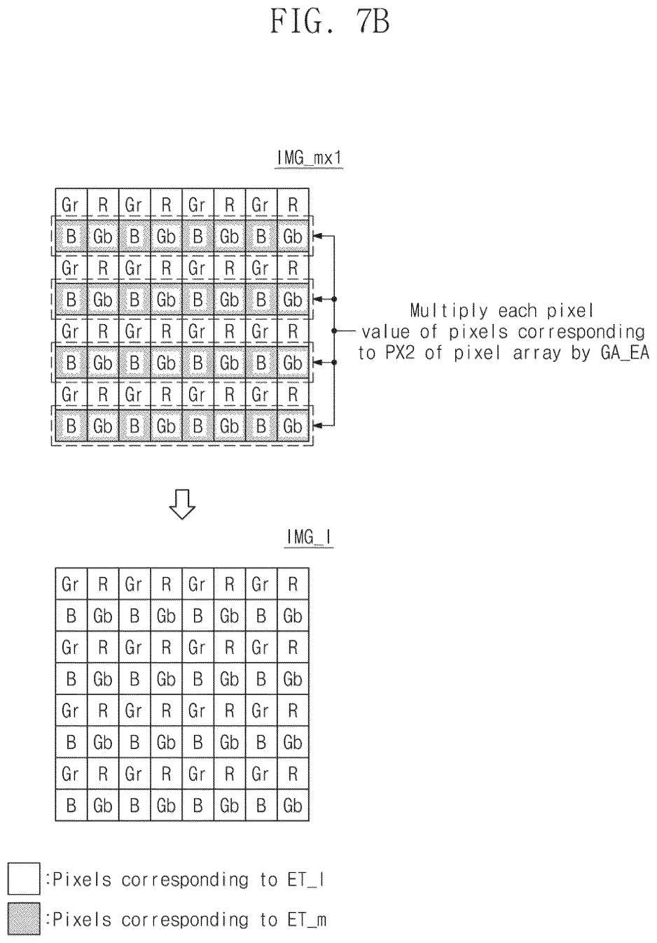

FIG. 7A is a diagram for describing the long-exposure image data generation module 111 of FIG. 3, and FIG. 7B is a diagram for describing operation S120 of FIG. 6. Referring to FIG. 7A, the long-exposure image data generation module 111 may include a first gain calculator (e.g., first gain calculation circuit) 111_a and a long-exposure image data generator (e.g., long-exposure image data generation circuit) 111_b.

The first gain calculator 111_a may receive the exposure time information ET_info. from the exposure time register REG_et. The exposure time information ET_info. may include information about the length of the long-exposure time ET_l and information about the length of the medium-exposure time ET_m. The first gain calculator 111_a may output, as the exposure time adjustment gain GA_EA, a value obtained by dividing the length of the long-exposure time ET_l by the length of the medium-exposure time ET_m. For example, the length of the long-exposure time ET_l may be 11 ms, and the length of the medium-exposure time ET_m may be 10 ms. In this case, the first gain calculator 111_a may output “11/10” as the exposure time adjustment gain GA_EA.

The long-exposure image data generator 111_b may receive the mixed image data IMG_mx from the ADC 114 and may receive the exposure time adjustment gain GA_EA from the first gain calculator 111_a. The long-exposure image data generator 111_b may generate the long-exposure image data IMG_l by multiplying the exposure time adjustment gain GA_EA and the pixel values corresponding to the second pixels PX2 from among the pixel values of the mixed image data IMG_mx together.

In detail, referring to FIG. 7B, the long-exposure image data generator 111_b may receive first mixed image data IMG_mx1 from the ADC 114. The first mixed image data IMG_mx1 may be data corresponding to analog signals generated by the pixel array 112 operating as described with reference to FIG. 3A (i.e., operating in a state where the long-exposure time ET_l is applied to the pixels PX of the odd-numbered rows and the medium-exposure time ET_m is applied to the pixels PX of the even-numbered rows).

According to the above description, the pixel value of each of the pixels included in the odd-numbered rows of the first mixed image data IMG_mx1 may correspond to an analog signal generated by the first pixel PX1 at the corresponding position of the pixel array 112 of FIG. 4A. Also, the pixel value of each of the pixels included in the even-numbered rows of the first mixed image data IMG_mx1 may correspond to an analog signal generated by the second pixel PX2 at the corresponding position of the pixel array 112 of FIG. 4A.

Accordingly, the pixels included in the odd-numbered rows of the first mixed image data IMG_mx1 may correspond to the long-exposure time ET_l. Also, the pixels included in the even-numbered rows of the first mixed image data IMG_mx1 may correspond to the medium-exposure time ET_m. The long-exposure image data generator 111_b may generate the long-exposure image data IMG_l by multiplying each of the pixel values of the pixels of the first mixed image data IMG_mx1, which belong to the even-numbered rows, and the exposure time adjustment gain GA_EA together.

As described above, the exposure time adjustment gain GA_EA may mean a ratio of the long-exposure time ET_l to the medium-exposure time ET_m. Accordingly, each of the pixel values of the even-numbered rows of the long-exposure image data IMG_l may have a brightness level similar to that of a pixel value generated by a pixel operating during the long-exposure time ET_l. According to the above description, the long-exposure image data IMG_l may correspond to the long-exposure time ET_l.

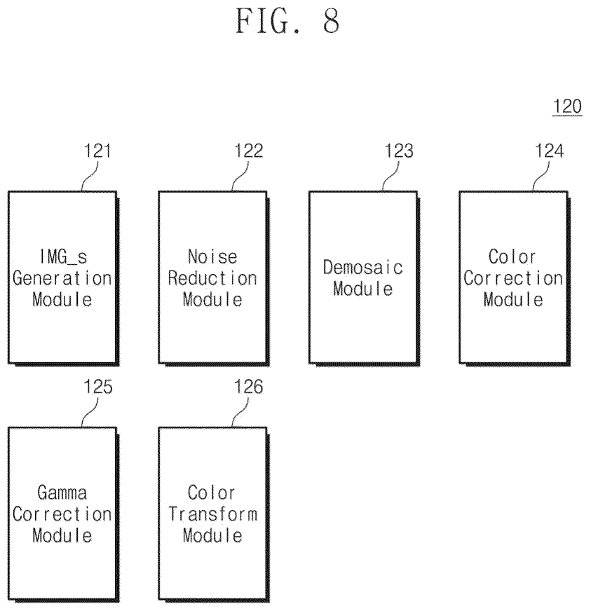

FIG. 8 is a block diagram illustrating an image signal processor of FIG. 1. The image signal processor 120 may perform signal processing or image processing on the long-exposure image data IMG_l from the image sensor 110. Referring to FIGS. 1 and 8, the image signal processor 120 may include a short-exposure image data generation module (e.g., short-exposure image data generation circuit) 121, a noise reduction module (e.g., noise reduction circuit) 122, a demosaic module (e.g., demosaic circuit) 123, a color correction module (e.g., color correction circuit) 124, a gamma correction module (e.g., gamma correction circuit) 125, and a color transform module (e.g., color transform circuit) 126.

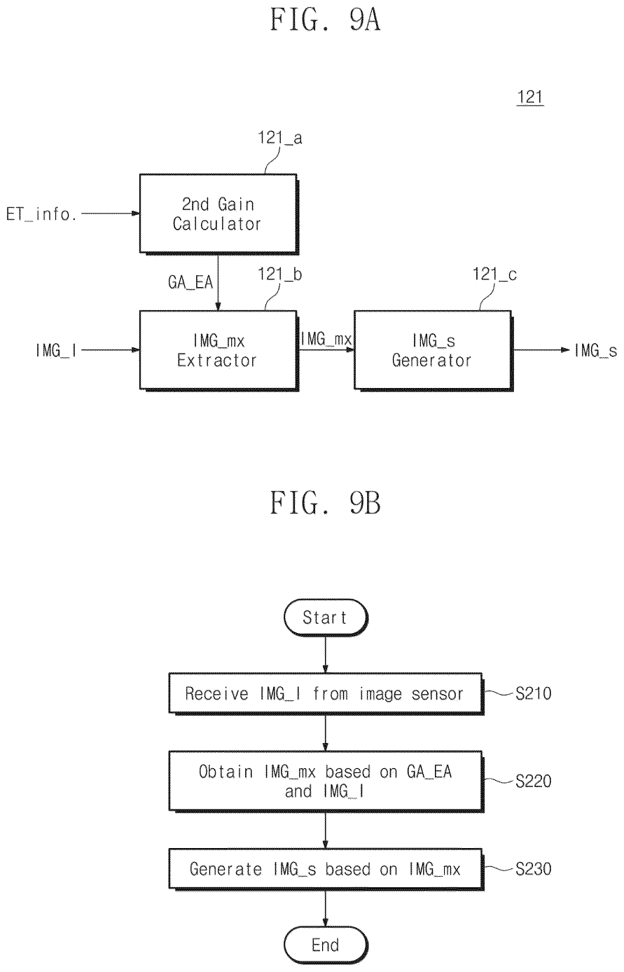

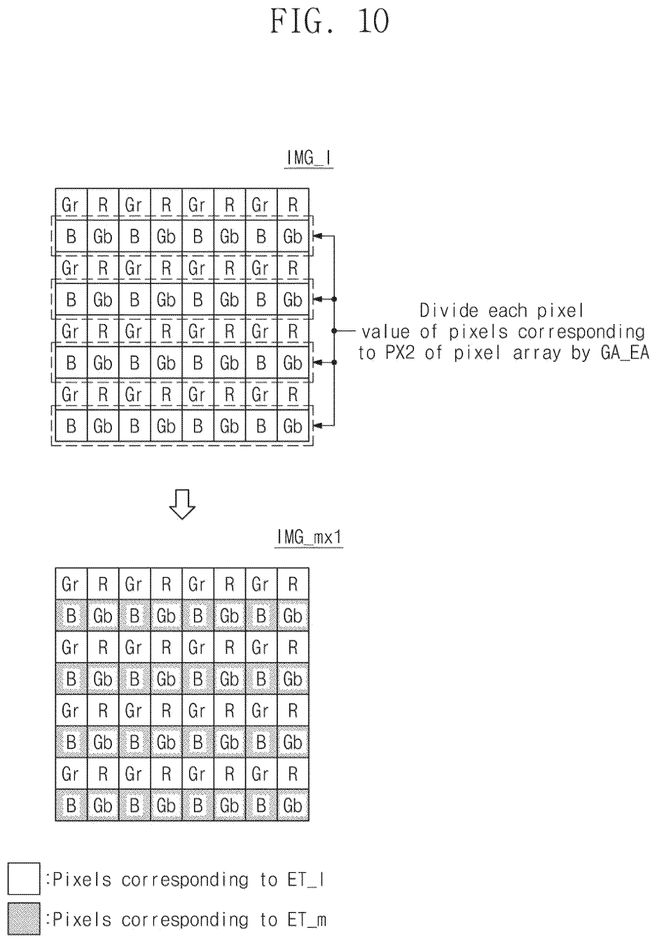

The short-exposure image data generation module 121 may obtain the mixed image data IMG_mx based on the long-exposure image data IMG_l. The short-exposure image data generation module 121 may generate short-exposure image data corresponding to the short-exposure time ET_s based on pixel values of the mixed image data IMG_mx, which correspond to the long-exposure time ET_l, and pixel values of the mixed image data IMG_mx, which correspond to the medium-exposure time ET_m. The operation of the short-exposure image data generation module 121 will be described in detail with reference to FIGS. 9A to 11C.

The noise reduction module 122 may be configured to remove the noise of the long-exposure image data IMG_l received from the image sensor 110. For example, the noise reduction module 122 may be configured to remove a fixed-pattern noise or a temporal random noise according to the color filter array (CFA) of the image sensor 110.

The demosaic module 123 may be configured to generate full-color data. For example, the long-exposure image data IMG_l may have a data format (e.g., a Bayer format or a tetra format) according to the pattern of the CFA of the image sensor 110. The demosaic module 123 may be configured to convert the data format according to the CFA pattern of the image sensor 110 into the RGB format.

The color correction module 124 may be configured to correct a color of image data converted into the RGB format. The gamma correction module 125 may be configured to correct a gamma value for an output from the color correction module 124.

The color transform module 126 may be configured to transform an output of the gamma correction module 125 into a specific format. For example, the output of the gamma correction module 125 may have the RGB format. The color transform module 126 may transform the RGB format into the YUV format.

In an embodiment, the configuration of the image signal processor 120 illustrated in FIG. 8 is provided as an example, and embodiments are not limited thereto. For example, the image signal processor 120 may further include additional components configured to perform any other signal processing operation, in addition to the above components.

FIG. 9A is a block diagram illustrating a short-exposure image data generation module of FIG. 8, and FIG. 9B is a flowchart for describing an operation method of an image signal processor of FIG. 8. FIGS. 9A and 9B will be described with reference to FIGS. 1, 3 to 4C, and 6 to 8. Referring to FIG. 9A, the short-exposure image data generation module 121 may include a second gain calculator (e.g., second gain calculation circuit) 121_a, a mixed image data extractor (e.g., mixed image data extraction circuit) 121_b, and a short-exposure image data generator (e.g., short-exposure image data generator circuit) 121_c.

Referring to FIG. 9B, in operation S210, the image signal processor 120 may receive the long-exposure image data IMG_l from the image sensor 110. For example, the mixed image data extractor 121_b may receive the long-exposure image data IMG_l from the image sensor 110.

In operation S220, the image signal processor 120 may obtain the mixed image data IMG_mx based on the exposure time adjustment gain GA_EA and the long-exposure image data IMG_l. For example, the second gain calculator 121_a may receive the exposure time information ET_info. currently applied to the image sensor 110 from the memory device included in the image signal processor 120. The exposure time information ET_info. may include information about the long-exposure time ET_l and the medium-exposure time ET_m. For example, the second gain calculator 121_a may output, as the exposure time adjustment gain GA_EA, a value obtained by dividing the length of the long-exposure time ET_l by the length of the medium-exposure time ET_m. For example, the length of the long-exposure time ET_l may be 11 ms, and the length of the medium-exposure time ET_m may be 10 ms. In this case, the second gain calculator 121_a may output “11/10” as the exposure time adjustment gain GA_EA. The mixed image data extractor 121_b may obtain the mixed image data IMG_mx by dividing each of pixel values of the long-exposure image data IMG_l, which correspond to the second pixels PX2, by the exposure time adjustment gain GA_EA.

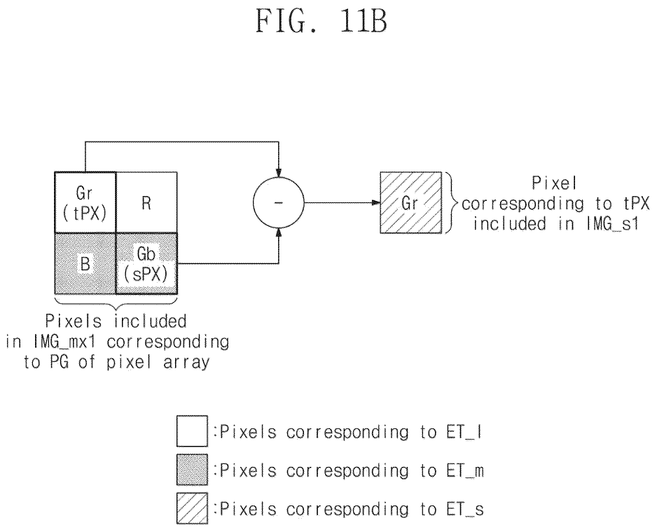

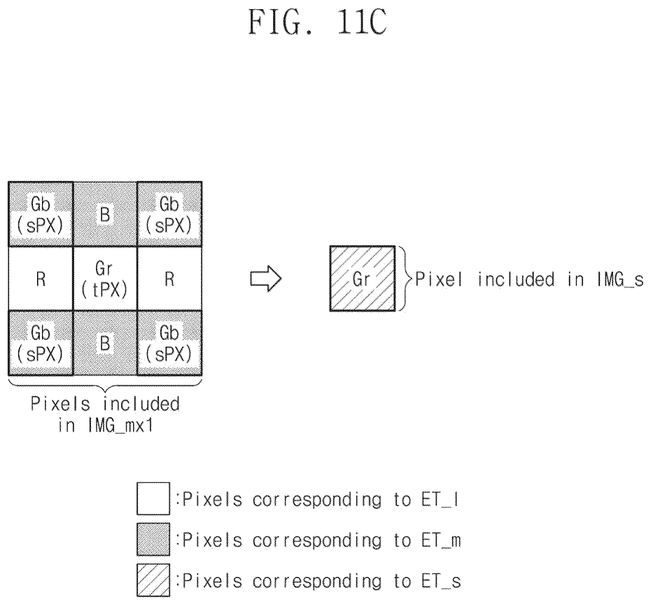

In operation S230, the image signal processor 120 may generate the short-exposure image data IMG_s based on the mixed image data IMG_mx. The short-exposure image data generator 121_c may generate the short-exposure image data IMG_s based on pixel values of the mixed image data IMG_mx, which correspond to the long-exposure time ET_l, and pixel values of the mixed image data IMG_mx, which correspond to the medium-exposure time ET_m. The method of generating the short-exposure image data IMG_s will be described in detail with reference to FIGS. 11A to 11C. The short-exposure image data IMG_s may correspond to the short-exposure time ET_s of FIG. 4C. Accordingly, the short-exposure image data IMG_s may be image data in which the motion blur is alleviated, compared to the long-exposure image data IMG_l.

As described above, according to an embodiment, the image sensor 110 may transmit only the long-exposure image data IMG_l to the image signal processor 120. The image signal processor 120 may generate the short-exposure image data IMG_s, in which the motion blur is alleviated, based on the long-exposure image data IMG_l. Accordingly, the performance of the image device 100 may be improved.

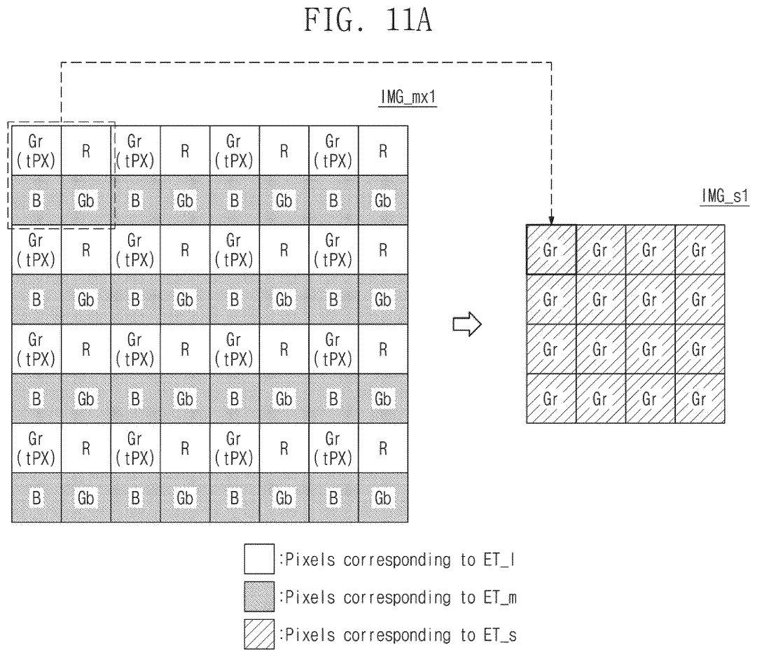

FIG. 10 is a diagram for describing operation S220 of FIG. 9B. Referring to FIGS. 9A to 10, the mixed image data extractor 121_b may receive the long-exposure image data IMG_l from the image sensor 110. Also, the mixed image data extractor 121_b may receive the exposure time adjustment gain GA_EA from the second gain calculator 121_a.

For example, the long-exposure image data IMG_l may be data generated based on the first mixed image data IMG_mx1 of FIG. 7B. That is, a pixel value of pixels included in even-numbered rows of the long-exposure image data IMG_l may be a value obtained by multiplying a pixel value generated based on the medium-exposure time ET_m (i.e., a pixel value corresponding to the second pixel PX2 of FIG. 4A) and the exposure time adjustment gain GA_EA together.

The mixed image data extractor 121_b may obtain the first mixed image data IMG_mx1 by dividing each of pixel values of pixels of the long-exposure image data IMG_l, which belong to the even-number row, by the exposure time adjustment gain GA_EA.

FIGS. 11A to 11C are diagrams for describing operation S230 of FIG. 9B. In detail, FIGS. 11A to 11C illustrate methods of generating first short-exposure image data IMG_s1 based on the first mixed image data IMG_mx1. FIGS. 11A to 11C will be described with reference to FIGS. 1, 3 to 4C, and 6 to 10.

Referring to FIG. 11A, in an embodiment, the short-exposure image data generator 121_c may generate the first short-exposure image data IMG_s1 including 16 pixels, based on the first mixed image data IMG_mx1 including 64 pixels. However, embodiments are not limited thereto. For example, the number of pixels included in image data may be changed. A pixel value of each of the pixels of the first short-exposure image data IMG_s1 may correspond to a target pixel tPX.

In an embodiment, the first short-exposure image data IMG_s1 may include only pixel values corresponding to the first color filter (e.g., Gr). According to the above description, the first short-exposure image data IMG_s1 may not include color information. In an embodiment, the short-exposure image data generator 121_c may calculate a pixel value of one pixel included in the first short-exposure image data IMG_s1 in units of four pixel values of the first mixed image data IMG_mx1, which correspond to the pixel group PG of the pixel array 112 illustrated in FIG. 4A.

For example, the pixel value of each of the pixels of the first short-exposure image data IMG_s1 may correspond to a pixel value generated by applying the short-exposure time ET_s to the first pixel PX1 of the pixel array 112 corresponding to the target pixel tPX. That is, the first short-exposure image data IMG_s1 may correspond to image data generated by applying the short-exposure time ET_s to a pixel array including 16 pixels. Accordingly, compared to the long-exposure image data IMG_l, the short-exposure image data IMG_s may be data in which the motion blur is alleviated.

Referring to FIG. 11B, in an embodiment, the short-exposure image data generator 121_c may calculate a difference between pixel values corresponding to the target pixel tPX and a surrounding pixel sPX from among the pixel values of the first mixed image data IMG_mx1 corresponding to the pixel group PG. The short-exposure image data generator 121_c may determine the calculated pixel value difference as a pixel value of a pixel of the first short-exposure image data IMG_s1 corresponding to the target pixel tPX. The pixel value of the target pixel tPX may be a pixel value corresponding to the first color filter (e.g., Gr). The pixel value of the surrounding pixel sPX may be a pixel value corresponding to the fourth color filter (e.g., Gb).

As described with reference to FIG. 4C, the pixel value of the target pixel tPX may be generated by applying the long-exposure time ET_l to the first pixel PX1 of the pixel array 112 corresponding to the target pixel tPX. The pixel value of the surrounding pixel sPX may be generated by applying the medium-exposure time ET_m to the second pixel PX2 of the pixel array 112 corresponding to the surrounding pixel sPX. In an embodiment, the surrounding pixel sPX may be a pixel placed at a position the closest to the target pixel tPX. Also, the surrounding pixel sPX may correspond to a color filter of the same color as the target pixel tPX. Accordingly, the pixel value of the surrounding pixel sPX may be a value similar to a pixel value generated by applying the medium-exposure time ET_m to the first pixel PX1 of the pixel array 112 corresponding to the target pixel tPX. Accordingly, the pixel value difference of the target pixel tPX and the surrounding pixel sPX may correspond to a pixel value generated by applying the short-exposure time ET_s to the first pixel PX1 of the pixel array 112 corresponding to the target pixel tPX.

Referring to FIG. 11C, unlike the example illustrated in FIG. 11B, in an embodiment, the short-exposure image data generator 121_c may calculate a pixel value of one pixel included in the short-exposure image data IMG_s, based on the pixel value of the target pixel tPX of the first mixed image data IMG_mx1 and pixel values of a plurality of surrounding pixels sPX placed around the target pixel tPX.

In detail, the short-exposure image data generator 121_c may calculate a difference between the pixel value of the target pixel tPX and an average of the pixel values of the surrounding pixels sPX. The short-exposure image data generator 121_c may determine the calculated value as a pixel value of a pixel of short-exposure image data IMG_s corresponding to the target pixel tPX. The pixel value of the target pixel tPX may correspond to the long-exposure time ET_l, and the pixel value of each of the surrounding pixels sPX may correspond to the medium-exposure time ET_m. Because the surrounding pixels sPX are pixels placed close to the target pixel tPX, the average of the pixel values of the surrounding pixels sPX may be a value similar to a pixel value generated by applying the medium-exposure time ET_m to the first pixel PX1 of the pixel array 112 corresponding to the target pixel tPX. Accordingly, the pixel value of the pixel of the first short-exposure image data IMG_s1 corresponding to the target pixel tPX may correspond to the pixel value generated by applying the short-exposure time ET_s to the first pixel PX1 corresponding to the target pixel tPX. The target pixel tPX and the surrounding pixels sPX may correspond to color filters of the same color. For example, the pixel value of the target pixel tPX may correspond to the first color filter (e.g., Gr), and the pixel values of the surrounding pixels sPX may correspond to the fourth color (e.g., Gb).

In an embodiment, in association with some of the plurality of target pixels tPX of the first mixed image data IMG_mx1, the short-exposure image data generator 121_c may calculate the pixel value of the first short-exposure image data IMG_s1 based on the pixel value of one surrounding pixel sPX; in association with the others of the plurality of target pixels tPX of the first mixed image data IMG_mx1, the short-exposure image data generator 121_c may calculate the pixel value of the first short-exposure image data IMG_s1 based on the pixel values of a plurality of surrounding pixels sPX.

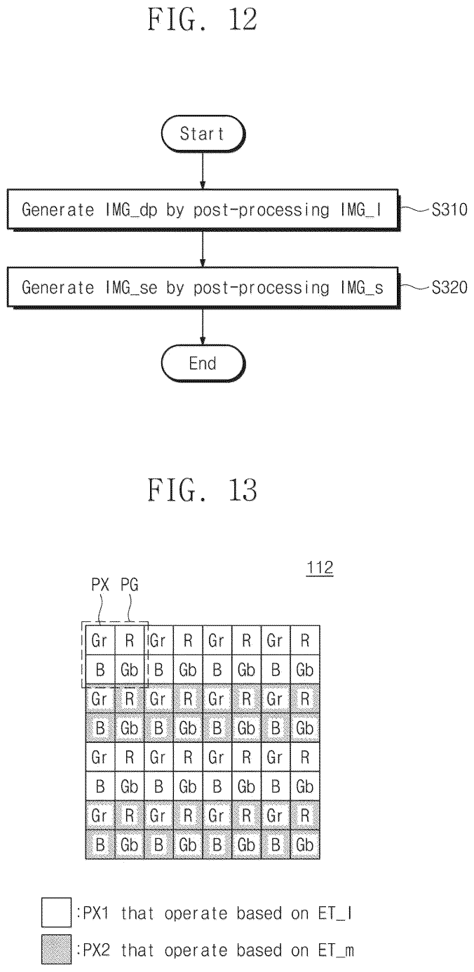

FIG. 12 is a diagram for describing an operation method of an image signal processor of FIG. 8. In an embodiment, the operation of FIG. 12 may be performed after the short-exposure image data IMG_s are generated by the short-exposure image data generation module 121.

Referring to FIG. 12, in operation S310, the image signal processor 120 may perform post-processing on the long-exposure image data IMG_l to generate display image data IMG_dp. For example, the image signal processor 120 may generate the display image data IMG_dp by performing post-processing based on the modules 122 to 126 of FIG. 8. The image signal processor 120 may provide the display image data IMG_dp to an external display device. For example, the display image data IMG_dp may be an image displayed through a display device of an electronic device including the image device 100.

In operation S320, the image signal processor 120 may generate sensing image data IMG_se by post-processing the short-exposure image data IMG_s. For example, the image signal processor 120 may generate the sensing image data IMG_se by performing the following post-processing operations on the short-exposure image data IMG_s: noise reduction and brightness correction. The image signal processor 120 may obtain information of an external object based on the sensing image data IMG_se. For example, the information of the external object may include information about a kind of the external object, a shape of the external object, a text included in the external object, etc. In an embodiment, the image signal processor 120 may transmit the sensing image data IMG_se to an external device configured to obtain the information of the external object.

As described above, compared to the short-exposure image data IMG_s, the long-exposure image data IMG_l may alleviate the LED flicker phenomenon and may improve a resolution. Accordingly, the image signal processor 120 may generate the display image data IMG_dp based on the long-exposure image data IMG_l and may use the display image data IMG_dp as an image (e.g., a human vision image) displayed on the outside through the display device.

Compared to the long-exposure image data IMG_l, the short-exposure image data IMG_s may be data in which the motion blur is alleviated. Accordingly, the image signal processor 120 may generate the sensing image data IMG_se based on the short-exposure image data IMG_s and may use the sensing image data IMG_se as an image (e.g., a computer vision image) for obtaining information of an external object.

FIG. 13 is a diagram for describing another example of a plurality of pixels of a pixel array of FIG. 3. Referring to FIGS. 1, 3, and 13, the pixel array 112 may include the plurality of pixel groups PG. The plurality of pixel groups PG may be arranged along a row direction and a column direction. Each of the plurality of pixel groups PG may include a plurality of pixels PX. For example, each of the plurality of pixel groups PG may include four pixels PX which respectively correspond to the color filters R, Gr, B, and Gb.

Each of the plurality of pixels PX may be configured to output an electrical signal corresponding to an incident light under control of the row driver 113. The plurality of pixels PX may respectively correspond to the color filters R, Gr, B, and Gb for receiving lights of specific wavelengths. Kinds and the arrangement of the color filters are provided as an example, and embodiments are not limited thereto.

The plurality of pixels PX may include the first pixels PX1 and the second pixels PX2. The long-exposure time ET_l may be applied to the first pixels PX1, and the medium-exposure time ET_m may be applied to the second pixels PX2.

For example, unlike the example illustrated in FIGS. 4A and 4B, an exposure time which is applied to the plurality of rows of the pixel array 112 in units of two rows may be changed. Pixels PX included in the first row, the second row, the fifth row, and the sixth row of the pixel array 112 may be the first pixels PX1 to which the long-exposure time ET_l is applied. Pixels PX included in the third row, the fourth row, the seventh row, and the eighth row of the pixel array 112 may be the second pixels PX2 to which the medium-exposure time ET_m is applied.

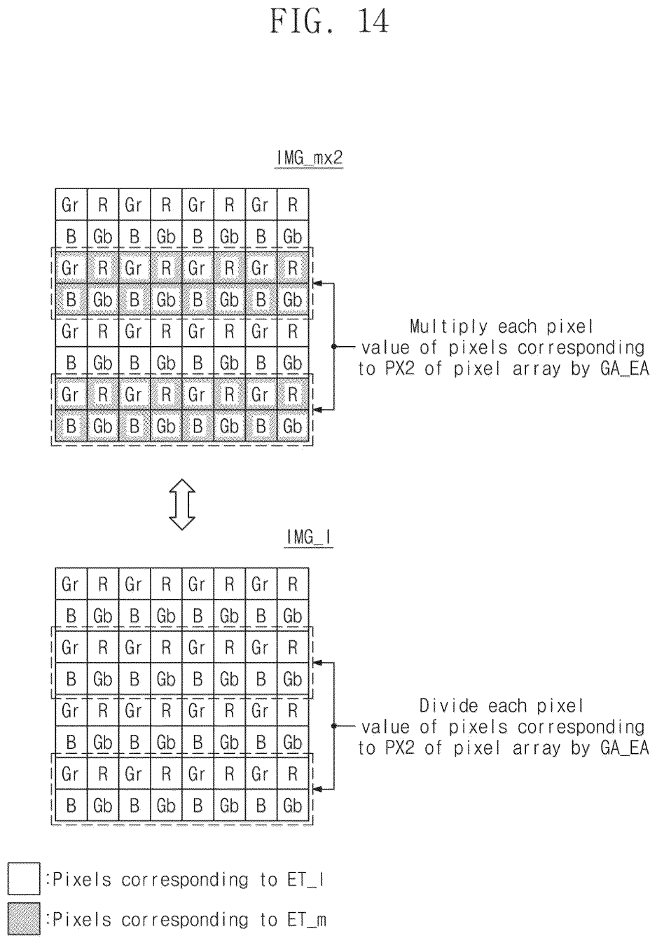

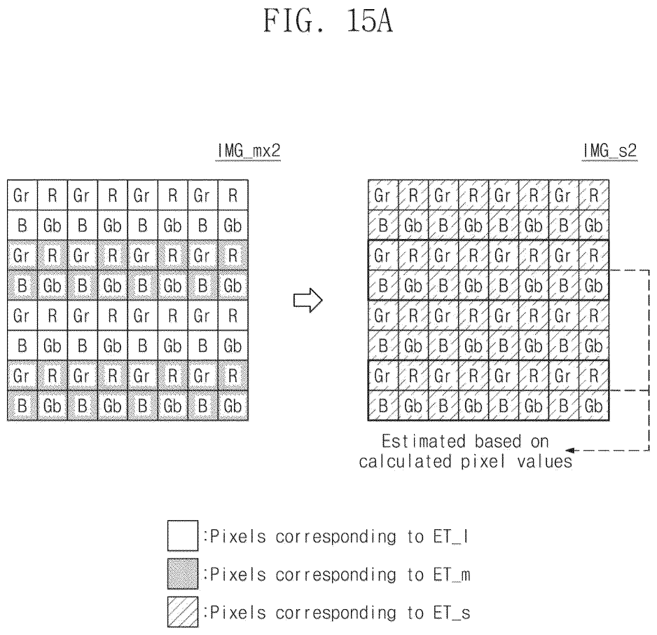

FIG. 14 is a diagram for describing mixed image data and long-exposure image data generated by an image sensor including a pixel array operating as described with reference to FIG. 13. Referring to FIGS. 1, 3 to 4C, and 6 to 14, when the exposure times described with reference to FIG. 13 are applied to the pixels of the pixel array 112, the image sensor 110 may generate second mixed image data IMG_mx2 (e.g., in operation S110 of FIG. 6). The pixels included in the third row, the fourth row, the seventh row, and the eighth row of the second mixed image data IMG_mx2 may correspond to the medium-exposure time ET_m. Accordingly, the long-exposure image data generation module 111 may generate the long-exposure image data IMG_l by multiplying the exposure time adjustment gain GA_EA and a pixel value of each of the pixels included in the third row, the fourth row, the seventh row, and the eighth row of the second mixed image data IMG_mx2 together (e.g., in operation S120 of FIG. 6).

The long-exposure image data generation module 121 of the image signal processor 120 may obtain the second mixed image data IMG_mx2 by dividing the pixel value of each of the pixels included in the third row, the fourth row, the seventh row, and the eighth row of the long-exposure image data IMG_l by the exposure time adjustment gain GA_EA (e.g., in operation S220 of FIG. 9B).

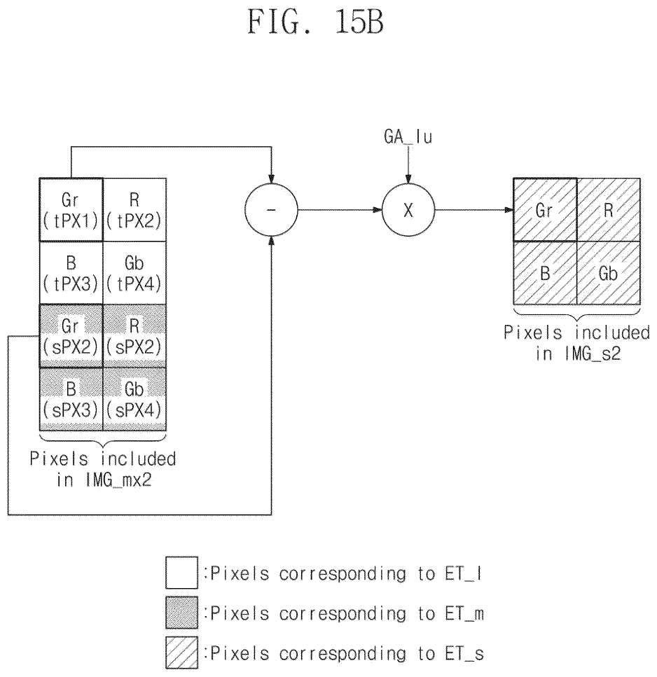

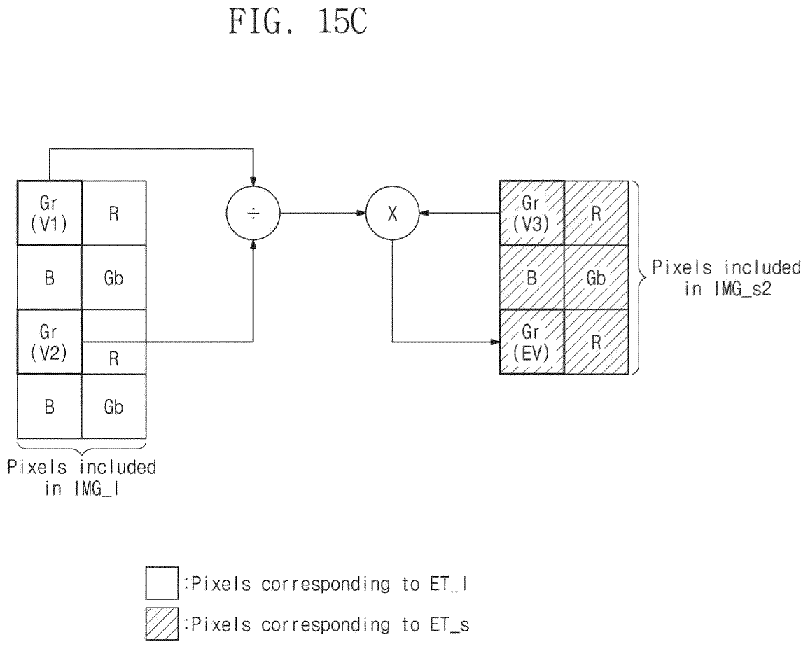

FIGS. 15A to 15C are diagrams for describing another example of operation S230 of FIG. 9B. FIGS. 15A to 15C are described based on the case where the image sensor 110 generates the long-exposure image data IMG_l based on the second mixed image data IMG_mx2.

Referring to FIG. 15A, unlike the case of FIG. 11A, the short-exposure image data generator 121_c may generate second short-exposure image data IMG_s2 including 64 pixels, based on the second mixed image data IMG_mx2 including 64 pixels. The second short-exposure image data IMG_s2 may include pixel values corresponding to the first color filter (e.g., Gr), the second color filter (e.g., R), the third color filter (e.g., B), and the fourth color filter (e.g., Gb). According to the above description, unlike the first short-exposure image data IMG_s1 of FIG. 11A, the second short-exposure image data IMG_s2 may include color information. Also, for example, the second short-exposure image data IMG_s2 may have the same resolution as the long-exposure image data IMG_l.

In an embodiment, the short-exposure image data generator 121_c may calculate pixel values of pixels of the first row and the second row of the second short-exposure image data IMG_s2, based on pixel values of pixels of the first row to the fourth row of the second mixed image data IMG_mx2. Also, the short-exposure image data generator 121_c may calculate pixel values of pixels of the fifth row and the sixth row of the second short-exposure image data IMG_s2, based on pixel values of pixels of the fifth row to the eighth row of the second mixed image data IMG_mx2.

In an embodiment, the short-exposure image data generator 121_c may estimate pixel values of pixels of the third row, the fourth row, the seventh row, and the eighth row of the second short-exposure image data IMG_s2, based on the calculated pixel values of the second short-exposure image data IMG_s2 and the pixel values of the long-exposure image data IMG_l.

In detail, referring to FIG. 15B, the short-exposure image data generator 121_c may calculate a pixel value of a pixel of the second short-exposure image data IMG_s2 corresponding to a first target pixel tPX1 corresponding to the long-exposure time ET_l by multiplying a brightness gain GA_lu and a value obtained by subtracting a pixel value of a first surrounding pixel sPX1 from the pixel value of the first target pixel tPX1. In an embodiment, the brightness gain GA_lu may mean a value obtained by dividing the length of the long-exposure time ET_l by the length of the short-exposure time ET_s. For example, the length of the long-exposure time ET_l may be 11 ms, and the length of the short-exposure time ET_s may be 1 ms. In this case, the short-exposure image data generator 121_c may output “11” (i.e., 11/1) as the brightness gain GA_lu. As the brightness gain GA_lu and the pixel value are multiplied, the second short-exposure image data IMG_s2 may correspond to the short-exposure time ET_s and may have the same brightness level as the long-exposure image data IMG_l.

The first surrounding pixel sPX1 may correspond to a color filter (e.g., Gb) of the same color as the first target pixel tPX1. Also, the first surrounding pixel sPX1 may be a pixel placed the closest to the first target pixel tPX1.

In this case, in an embodiment, unlike the example illustrated in FIG. 9A, the second gain calculator 121_a may be further configured to receive the exposure time information ET_info. including information about the short-exposure time ET_s, to generate the brightness gain GA_lu based on the exposure time information ET_info, and to transmit the brightness gain GA_lu to the short-exposure image data generator 121_c.

The short-exposure image data generator 121_c may calculate a pixel value of a pixel of the second mixed image data IMG_mx2 based on the pixel values of a second target pixel tPX2 and a second surrounding pixel sPX2. In this case, the pixel of the second mixed image data IMG_mx2 may correspond to the second color filter (e.g., R) and the second target pixel tPX2.

Also, the short-exposure image data generator 121_c may calculate a pixel value of a pixel of the second mixed image data IMG_mx2 based on pixel values of a third target pixel tPX3 and a third surrounding pixel sPX3. In this case, the pixel of the second mixed image data IMG_mx2 may correspond to the third color filter (e.g., B) and the third target pixel tPX3.

In addition, the short-exposure image data generator 121_c may calculate a pixel value of a pixel of the second mixed image data IMG_mx2 based on pixel values of a fourth target pixel tPX4 and a fourth surrounding pixel sPX4. In this case, the pixel of the second mixed image data IMG_mx2 may correspond to the fourth color filter (e.g., Gb) and the fourth target pixel tPX4.

FIG. 15B shows an example where the pixel value of the second short-exposure image data IMG_s2 corresponding to the target pixel (e.g., tPX1) is calculated based on the pixel value of one surrounding pixel (e.g., sPX1), but embodiments are not limited thereto. That is, in an embodiment, as described with reference to FIG. 11C, the short-exposure image data generator 121_c may calculate the pixel value of the second short-exposure image data IMG_s2 based on an average of pixel values of a plurality of surrounding pixels corresponding to a color filter (e.g., Gb) of the same color as the target pixel (e.g., tPX1).

Referring to FIG. 15C, in an embodiment, the short-exposure image data generator 121_c may estimate the pixel value of the second short-exposure image data IMG_s2 corresponding to the surrounding pixels (e.g., sPX1).

For example, a pixel value of a pixel of the long-exposure image data IMG_l corresponding to the first target pixel tPX1 of the second mixed image data IMG_mx2 may be a first value V1. Also, a pixel value of a pixel of the long-exposure image data IMG_l corresponding to the first surrounding pixel sPX1 of the second mixed image data IMG_mx2 may be a second value V2. Also, a pixel value of the second short-exposure image data IMG_s2 corresponding to the first target pixel tPX1 may be a third value V3.

In this case, the short-exposure image data generator 121_c may determine an estimation value EV indicating a result of multiplying the third value V3 and a value obtained by dividing the second value V2 by the first value 1 as the pixel value of the second short-exposure image data IMG_s2.

However, FIG. 15C shows only an example of calculating the estimation value EV, and embodiments are not limited thereto. The short-exposure image data generator 121_c may estimate the pixel values of the pixels of the second short-exposure image data IMG_s2 in various methods.

Unlike the example illustrated in FIG. 9A, in the case of performing calculation illustrated in FIG. 15C, the short-exposure image data generator 121_c may be further configured to receive the long-exposure image data IMG_l.

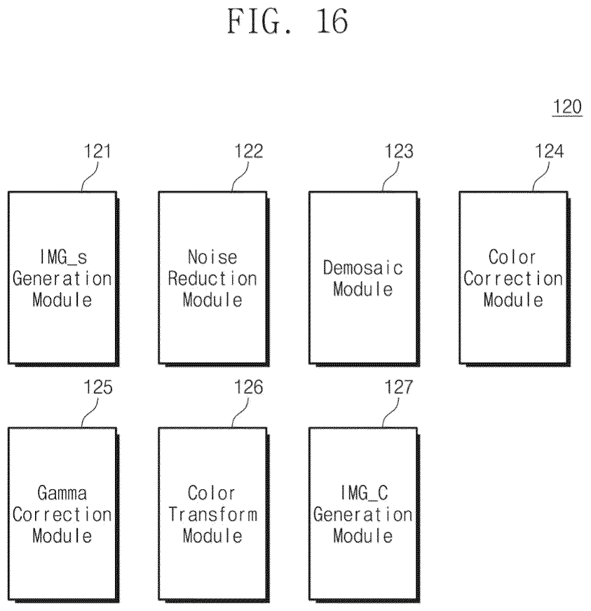

FIG. 16 is a block diagram for describing another example of an image signal processor of FIG. 1. The image signal processor 120 may include the short-exposure image data generation module 121, the noise reduction module 122, the demosaic module 123, the color correction module 124, the gamma correction module 125, the color transform module 126, and a combined image data generation module (e.g., combined image data generation circuit) 127.

In the example of FIG. 16, the short-exposure image data generation module 121 may be configured to generate the second short-exposure image data IMG_s2 in the method described with reference to FIGS. 15A to 15C. The noise reduction module 122, the demosaic module 123, the color correction module 124, the gamma correction module 125, and the color transform module 126 are described with reference to FIG. 8, and thus, additional description will be omitted to avoid redundancy.

The combined image data generation module 127 may generate combined image data IMG_C based on the long-exposure image data IMG_l and the second short-exposure image data IMG_s2. The combined image data generation module 127 may change data in the blur region included in the long-exposure image data IMG_l to data of the second short-exposure image data IMG_s2. Accordingly, the combined image data generation module 127 may generate the combined image data IMG_C in which the motion blur is improved.

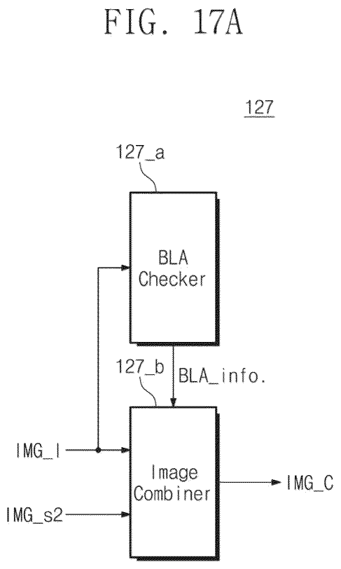

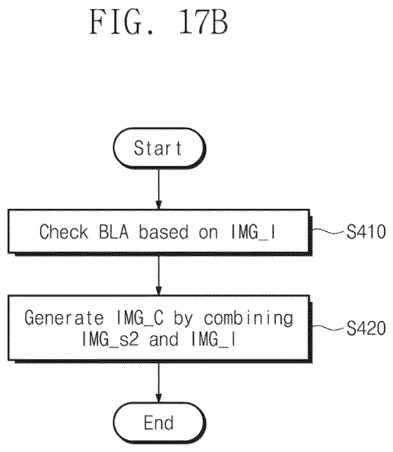

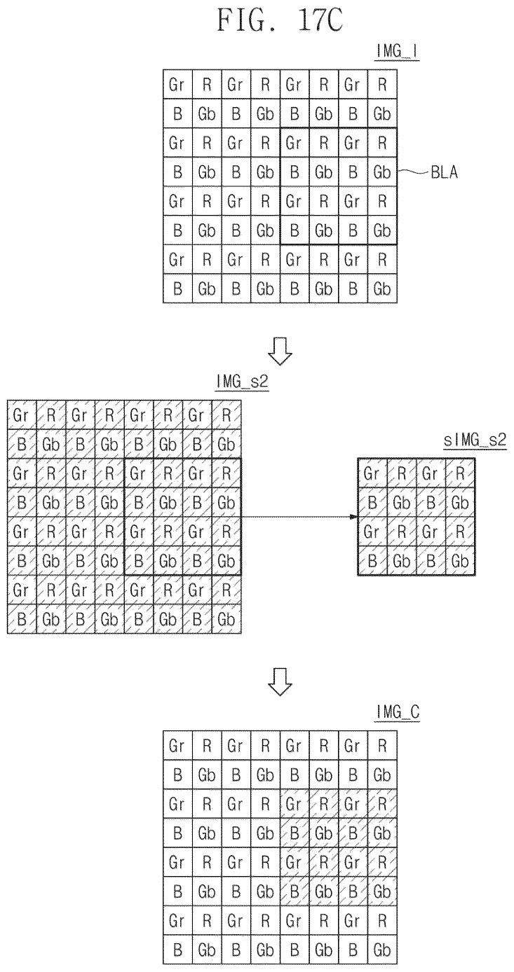

FIG. 17A is a block diagram for describing a combined image data generation module of FIG. 16. FIG. 17B is a flowchart for describing an operation method of an image signal processor of FIG. 16. FIG. 17C is a diagram for describing operation S420 of FIG. 17B. Referring to FIG. 17A, the combined image data generation module 127 may include a blur region checker (e.g., blur region checking circuit) 127_a and an image combiner (e.g., image combiner circuit) 127_b.

Referring to FIG. 17B, in operation S410, the image signal processor 120 may check (e.g., identify) the blur region based on the long-exposure image data IMG_l. For example, the blur region checker 127_a may receive the long-exposure image data IMG_l. The blur region checker 127_a may check (e.g., identify) a position of the blur region indicating a region of the long-exposure image data IMG_l, in which the motion blur occurs. The blur region checker 127_a may generate blur region information BLA_info. including information about the position of the blur region.

In operation S420, the image signal processor 120 may generate the combined image data IMG_C by combining the second short-exposure image data IMG_s2 and the long-exposure image data IMG_l. For example, the image combiner 127_b may receive the long-exposure image data IMG_l, the second short-exposure image data IMG_s2, and the blur region information BLA_info. The image combiner 127_b may check the position of the blur region based on the blur region information BLA_info. The image combiner 127_b may change pixel values of pixels included in the blur region of the long-exposure image data IMG_l to pixel values of pixels corresponding to the blur region of the second short-exposure image data IMG_s2. According to the above description, the image combiner 127_b may generate the combined image data IMG_C by combining the long-exposure image data IMG_l and the second short-exposure image data IMG_s2.

In detail, referring to FIG. 17C, the image combiner 127_b may extract a sub-second short-exposure image data sIMG_s2 corresponding to a blur region BLA from the second short-exposure image data IMG_s2. The image combiner 127_b may generate the combined image data IMG_C by replacing data of the long-exposure image data IMG_l corresponding to the blur region BLA with the sub-second short-exposure image data sIMG_s2.

In an embodiment, the image signal processor 120 may use the combined image data IMG_C as an image (e.g., a human vision image) displayed on the outside through the display device and an image (e.g., a computer vision image) for obtaining information of an external object.

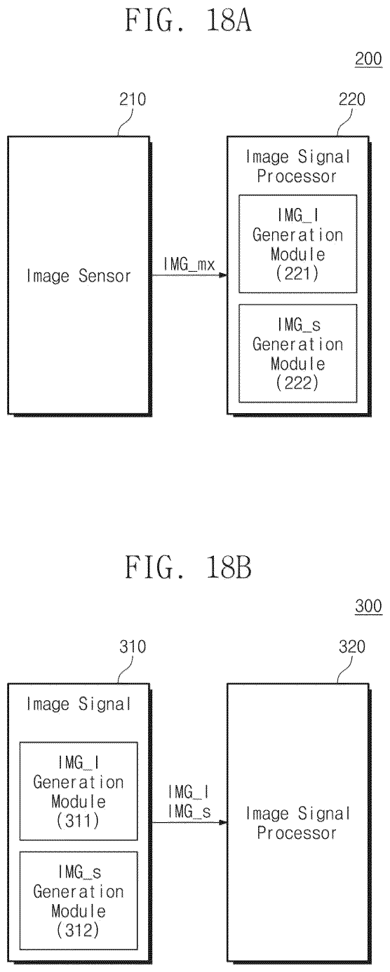

FIGS. 18A and 18B are diagrams for describing other examples of an image device according to an embodiment. Referring to FIG. 18A, an image device 200 may include an image sensor 210 and an image signal processor 220. The image sensor 210 may generate the mixed image data IMG_mx corresponding to the long-exposure time ET_l and the medium-exposure time ET_m. The image sensor 210 may include a pixel array including a plurality of pixels. For example, the exposure times described with reference to FIG. 4A may be applied to the pixels of the pixel array. In this case, the image sensor 210 may generate the first mixed image data IMG_mx1 of FIG. 7B. For example, the exposure times described with reference to FIG. 13 may be applied to the pixels of the pixel array. In this case, the image sensor 210 may generate the second mixed image data IMG_mx2 of FIG. 14.

The image signal processor 220 may receive the mixed image data IMG_mx from the image sensor 210 and may perform various signal processing operations on the received mixed image data IMG_mx. The image signal processor 220 may include a long-exposure image data generation module (e.g., long-exposure image data generation circuit) 221 and a short-exposure image data generation module (e.g., short-exposure image data generation circuit) 222. The long-exposure image data generation module 221 may generate the long-exposure image data IMG_l by adjusting the pixel values of the mixed image data IMG_mx in the method described with reference to FIGS. 1 to 16C. The short-exposure image data generation module 222 may generate the short-exposure image data IMG_s based on the pixel values of the mixed image data IMG_mx in the method described with reference to FIGS. 1 to 17C. Compared to the long-exposure image data IMG_l, the short-exposure image data IMG_s may be image data in which the motion blur is alleviated.

That is, according to the embodiment of FIG. 18A, unlike the image sensor 110 of FIG. 1, the image sensor 210 may generate the mixed image data IMG_mx. Unlike the image signal processor 120 of FIG. 1, the image signal processor 220 may be configured to generate both the long-exposure image data IMG_l and the short-exposure image data IMG_s.

Referring to FIG. 18B, an image device 300 may include an image sensor 310 and an image signal processor 320. Unlike the case of FIGS. 1 to 18A, the image sensor 310 may include a long-exposure image data generation module (e.g., long-exposure image data generation circuit) 311 and a short-exposure image data generation module (e.g., short-exposure image data generation circuit) 312. According to the above description, unlike the case of FIGS. 1 to 17A, the image sensor 310 may generate both the long-exposure image data IMG_l and the short-exposure image data IMG_s and may transmit the long-exposure image data IMG_l and the short-exposure image data IMG_s to the image signal processor 320. The image sensor 310 may generate the long-exposure image data IMG_l and the short-exposure image data IMG_s in the method described with reference to FIGS. 1 to 17C.

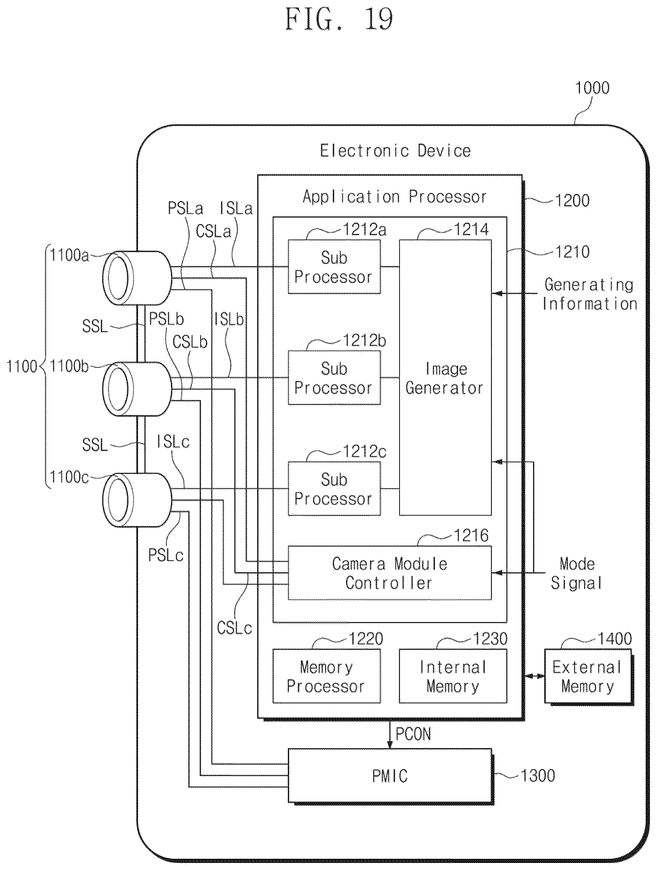

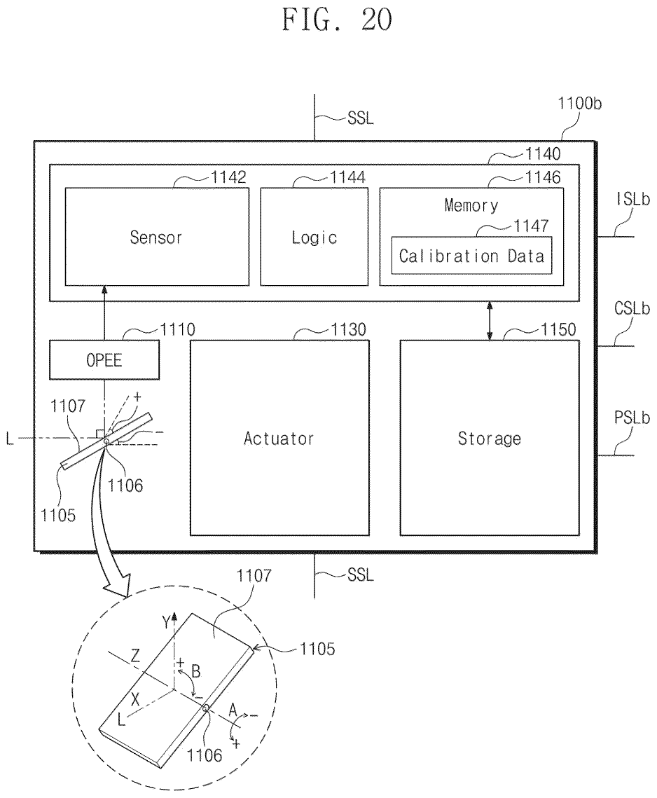

FIG. 19 is a block diagram of an electronic device including a multi-camera module. FIG. 20 is a block diagram illustrating a camera module of FIG. 19 in detail.

Referring to FIG. 19, an electronic device 1000 may include a camera module group 1100, an application processor 1200, a PMIC 1300, and an external memory 1400.

The camera module group 1100 may include a plurality of camera modules 1100a, 1100b, and 1100c. An electronic device including three camera modules 1100a, 1100b, and 1100c is illustrated in FIG. 19, but embodiments are not limited thereto. In some embodiments, the camera module group 1100 may be modified to include only two camera modules. Also, in some embodiments, the camera module group 1100 may be modified to include “n” camera modules (n being a natural number of 4 or more).

In an embodiment, the image sensor of FIG. 1 may be included in the camera module group 1100. In an embodiment, the image signal processor 120 of FIG. 1 may be included in the application processor 1200. However, embodiments are not limited thereto.

Below, a detailed configuration of the camera module 1100b will be more fully described with reference to FIG. 20, but the following description may be equally applied to the remaining camera modules 1100a and 1100c.

Referring to FIG. 20, the camera module 1100b may include a prism 1105, an optical path folding element (OPFE) 1110, an actuator 1130, an image sensing device 1140, and storage 1150.

The prism 1105 may include a reflecting plane 1107 of a light reflecting material and may change a path of a light “L” incident from the outside.

In some embodiments, the prism 1105 may change a path of the light “L” incident in a first direction (X) to a second direction (Y) perpendicular to the first direction (X), Also, the prism 1105 may change the path of the light “L” incident in the first direction (X) to the second direction (Y) perpendicular to the first (X-axis) direction by rotating the reflecting plane 1107 of the light reflecting material in direction “A” about a central axis 1106 or rotating the central axis 1106 in direction “B”. In this case, the OPFE 1110 may move in a third direction (Z) perpendicular to the first direction (X) and the second direction (Y).

In some embodiments, as illustrated in FIG. 20, a maximum rotation angle of the prism 1105 in direction “A” may be equal to or smaller than 15 degrees in a positive A direction and may be greater than 15 degrees in a negative A direction, but embodiments are not limited thereto.

In some embodiments, the prism 1105 may move within approximately 20 degrees in a positive or negative B direction, between 10 degrees and 20 degrees, or between 15 degrees and 20 degrees; here, the prism 1105 may move at the same angle in the positive or negative B direction or may move at a similar angle within approximately 1 degree.

In some embodiments, the prism 1105 may move the reflecting plane 1107 of the light reflecting material in the third direction (e.g., Z direction) parallel to a direction in which the central axis 1106 extends.

The OPFE 1110 may include optical lenses composed of “m” groups (m being a natural number), for example. Here, “m” lens may move in the second direction (Y) to change an optical zoom ratio of the camera module 1100b. For example, when a default optical zoom ratio of the camera module 1100b is “Z”, the optical zoom ratio of the camera module 1100b may be changed to an optical zoom ratio of 3 Z, 5 Z, or 5 Z or more by moving “m” optical lens included in the OPFE 1110.

The actuator 1130 may move the OPFE 1110 or an optical lens (hereinafter referred to as an “optical lens”) to a specific location. For example, the actuator 1130 may adjust a location of an optical lens such that an image sensor 1142 is placed at a focal length of the optical lens for accurate sensing.

The image sensing device 1140 may include the image sensor 1142, control logic 1144, and a memory 1146. The image sensor 1142 may sense an image of a sensing target by using the light “L” provided through an optical lens. The control logic 1144 may control overall operations of the camera module 1100b. For example, the control logic 1144 may control an operation of the camera module 1100b based on a control signal provided through a control signal line CSLb.

The memory 1146 may store information, which is necessary for an operation of the camera module 1100b, such as calibration data 1147. The calibration data 1147 may include information necessary for the camera module 1100b to generate image data by using the light “L” provided from the outside. The calibration data 1147 may include, for example, information about the degree of rotation described above, information about a focal length, information about an optical axis, etc. In the case where the camera module 1100b is implemented in the form of a multi-state camera in which a focal length varies depending on a location of an optical lens, the calibration data 1147 may include a focal length value for each location (or state) of the optical lens and information about auto focusing.

The storage 1150 may store image data sensed through the image sensor 1142. The storage 1150 may be disposed outside the image sensing device 1140 and may be implemented in a shape where the storage 1150 and a sensor chip constituting the image sensing device 1140 are stacked. In some embodiments, the storage 1150 may be implemented with an electrically erasable programmable read only memory (EEPROM), but embodiments are not limited thereto.

Referring together to FIGS. 19 and 20, in some embodiments, each of the plurality of camera modules 1100a, 1100b, and 1100c may include the actuator 1130. As such, the same calibration data 1147 or different calibration data 1147 may be included in the plurality of camera modules 1100a, 1100b, and 1100c depending on operations of the actuators 1130 therein.

In some embodiments, one camera module (e.g., 1100b) among the plurality of camera modules 1100a, 1100b, and 1100c may be a folded lens shape of camera module in which the prism 1105 and the OPFE 1110 described above are included, and the remaining camera modules (e.g., 1100a and 1100c) may be a vertical shape of camera module in which the prism 1105 and the OPFE 1110 described above are not included; however, embodiments are not limited thereto.

In some embodiments, one camera module (e.g., 1100c) among the plurality of camera modules 1100a, 1100b, and 1100c may be, for example, a vertical shape of depth camera extracting depth information by using an infrared ray (IR). In this case, the application processor 1200 may merge image data provided from the depth camera and image data provided from any other camera module (e.g., 1100a or 1100b) and may generate a three-dimensional (3D) depth image.

In some embodiments, at least two camera modules (e.g., 1100a and 1100b) among the plurality of camera modules 1100a, 1100b, and 1100c may have different fields of view. In this case, the at least two camera modules (e.g., 1100a and 1100b) among the plurality of camera modules 1100a, 1100b, and 1100c may include different optical lens, but embodiments are not limited thereto.

Also, in some embodiments, fields of view of the plurality of camera modules 1100a, 1100b, and 1100c may be different. In this case, the plurality of camera modules 1100a, 1100b, and 1100c may include different optical lens, not limited thereto.

In some embodiments, the plurality of camera modules 1100a, 1100b, and 1100c may be disposed to be physically separated from each other. That is, the plurality of camera modules 1100a, 1100b, and 1100c may not use a sensing area of one image sensor 1142, but the plurality of camera modules 1100a, 1100b, and 1100c may include independent image sensors 1142 therein, respectively.

Returning to FIG. 19, the application processor 1200 may include an image processing device 1210, a memory controller 1220, and an internal memory 1230. The application processor 1200 may be implemented to be separated from the plurality of camera modules 1100a, 1100b, and 1100c. For example, the application processor 1200 and the plurality of camera modules 1100a, 1100b, and 1100c may be implemented with separate semiconductor chips.

The image processing device 1210 may include a plurality of sub image processors 1212a, 1212b, and 1212c, an image generator 1214, and a camera module controller 1216.

The image processing device 1210 may include the plurality of sub image processors 1212a, 1212b, and 1212c, the number of which corresponds to the number of the plurality of camera modules 1100a, 1100b, and 1100c.

Image data respectively generated from the camera modules 1100a, 1100b, and 1100c may be respectively provided to the corresponding sub image processors 1212a, 1212b, and 1212c through separated image signal lines ISLa, ISLb, and ISLc. For example, the image data generated from the camera module 1100a may be provided to the sub image processor 1212a through the image signal line ISLa, the image data generated from the camera module 1100b may be provided to the sub image processor 1212b through the image signal line ISLb, and the image data generated from the camera module 1100c may be provided to the sub image processor 1212c through the image signal line ISLc. This image data transmission may be performed, for example, by using a camera serial interface (CSI) based on the MIPI (Mobile Industry Processor Interface), but embodiments are not limited thereto.

In some embodiments, one sub image processor may be disposed to correspond to a plurality of camera modules. For example, the sub image processor 1212a and the sub image processor 1212c may be integrally implemented, not separated from each other as illustrated in FIG. 16; in this case, one of the pieces of image data respectively provided from the camera module 1100a and the camera module 1100c may be selected through a selection element (e.g., a multiplexer), and the selected image data may be provided to the integrated sub image processor.

The image data respectively provided to the sub image processors 1212a, 1212b, and 1212c may be provided to the image generator 1214. The image generator 1214 may generate an output image by using the image data respectively provided from the sub image processors 1212a, 1212b, and 1212c, depending on image generating information Generating Information or a mode signal.

In detail, the image generator 1214 may generate the output image by merging at least a portion of the image data respectively generated from the camera modules 1100a, 1100b, and 1100c having different fields of view, depending on the image generating information Generating Information or the mode signal. Also, the image generator 1214 may generate the output image by selecting one of the image data respectively generated from the camera modules 1100a, 1100b, and 1100c having different fields of view, depending on the image generating information Generating Information or the mode signal.

In some embodiments, the image generating information Generating Information may include a zoom signal or a zoom factor. Also, in some embodiments, the mode signal may be, for example, a signal based on a mode selected from a user.

In the case where the image generating information Generating Information is the zoom signal (or zoom factor) and the camera modules 1100a, 1100b, and 1100c have different visual fields of view, the image generator 1214 may perform different operations depending on a kind of the zoom signal. For example, in the case where the zoom signal is a first signal, the image generator 1214 may merge the image data output from the camera module 1100a and the image data output from the camera module 1100c and may generate the output image by using the merged image signal and the image data output from the camera module 1100b that is not used in the merging operation. In the case where the zoom signal is a second signal different from the first signal, without the image data merging operation, the image generator 1214 may select one of the image data respectively output from the camera modules 1100a, 1100b, and 1100c and may output the selected image data as the output image. However, embodiments are not limited thereto, and a way to process image data may be modified without limitation if necessary.

In some embodiments, the image generator 1214 may generate merged image data having an increased dynamic range by receiving a plurality of image data of different exposure times from at least one of the plurality of sub image processors 1212a, 1212b, and 1212c and performing high dynamic range (HDR) processing on the plurality of image data.

The camera module controller 1216 may provide control signals to the camera modules 1100a, 1100b, and 1100c, respectively. The control signals generated from the camera module controller 1216 may be respectively provided to the corresponding camera modules 1100a, 1100b, and 1100c through control signal lines CSLa, CSLb, and CSLc separated from each other.

One of the plurality of camera modules 1100a, 1100b, and 1100c may be designated as a master camera (e.g., 1100b) depending on the image generating information Generating Information including a zoom signal or the mode signal, and the remaining camera modules (e.g., 1100a and 1100c) may be designated as a slave camera. The above designation information may be included in the control signals, and the control signals including the designation information may be respectively provided to the corresponding camera modules 1100a, 1100b, and 1100c through the control signal lines CSLa, CSLb, and CSLc separated from each other.

Camera modules operating as a master and a slave may be changed depending on the zoom factor or an operating mode signal. For example, in the case where the field of view of the camera module 1100a is wider than the field of view of the camera module 1100b and the zoom factor indicates a low zoom ratio, the camera module 1100b may operate as a master, and the camera module 1100a may operate as a slave. In contrast, in the case where the zoom factor indicates a high zoom ratio, the camera module 1100a may operate as a master, and the camera module 1100b may operate as a slave.

In some embodiments, the control signal provided from the camera module controller 1216 to each of the camera modules 1100a, 1100b, and 1100c may include a sync enable signal. For example, in the case where the camera module 1100b is used as a master camera and the camera modules 1100a and 1100c are used as a slave camera, the camera module controller 1216 may transmit the sync enable signal to the camera module 1100b. The camera module 1100b that is provided with sync enable signal may generate a sync signal based on the provided sync enable signal and may provide the generated sync signal to the camera modules 1100a and 1100c through a sync signal line SSL. The camera module 1100b and the camera modules 1100a and 1100c may be synchronized with the sync signal to transmit image data to the application processor 1200.

In some embodiments, the control signal provided from the camera module controller 1216 to each of the camera modules 1100a, 1100b, and 1100c may include mode information according to the mode signal. Based on the mode information, the plurality of camera modules 1100a, 1100b, and 1100c may operate in a first operating mode and a second operating mode with regard to a sensing speed.

In the first operating mode, the plurality of camera modules 1100a, 1100b, and 1100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 1200. In this case, the second speed may be 30 times or less the first speed.

The application processor 1200 may store the received image signals, that is, the encoded image signals in the memory 1230 provided therein or the external memory 1400 placed outside the application processor 1200. Afterwards, the application processor 1200 may read and decode the encoded image signals from the memory 1230 or the external memory 1400 and may display image data generated based on the decoded image signals. For example, the corresponding one among sub image processors 1212a, 1212b, and 1212c of the image processing device 1210 may perform decoding and may also perform image processing on the decoded image signal.

In the second operating mode, the plurality of camera modules 1100a, 1100b, and 1100c may generate image signals at a third speed (e.g., may generate image signals of a third frame rate lower than the first frame rate) and transmit the image signals to the application processor 1200. The image signals provided to the application processor 1200 may be signals that are not encoded. The application processor 1200 may perform image processing on the received image signals or may store the image signals in the memory 1230 or the external memory 1400.

The PMIC 1300 may supply powers, for example, power supply voltages to the plurality of camera modules 1100a, 1100b, and 1100c, respectively. For example, under control of the application processor 1200, the PMIC 1300 may supply a first power to the camera module 1100a through a power signal line PSLa, may supply a second power to the camera module 1100b through a power signal line PSLb, and may supply a third power to the camera module 1100c through a power signal line PSLc.

In response to a power control signal PCON from the application processor 1200, the PMIC 1300 may generate a power corresponding to each of the plurality of camera modules 1100a, 1100b, and 1100c and may adjust a level of the power. The power control signal PCON may include a power adjustment signal for each operating mode of the plurality of camera modules 1100a, 1100b, and 1100c. For example, the operating mode may include a low-power mode. In this case, the power control signal PCON may include information about a camera module operating in the low-power mode and a set power level. Levels of the powers respectively provided to the plurality of camera modules 1100a, 1100b, and 1100c may be identical to each other or may be different from each other. Also, a level of a power may be dynamically changed.

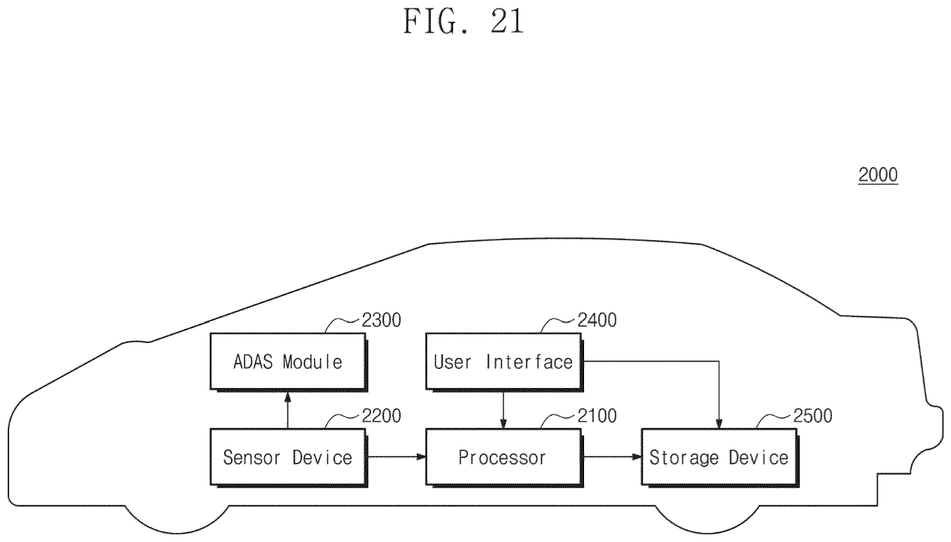

FIG. 21 is a diagram illustrating an autonomous driving system according to an embodiment. Referring to FIG. 21, an autonomous driving system 2000 may include a processor 2100, a sensor device 2200, an advanced driver assistance system (ADAS) module 2300, a user interface 2400, and a storage device 2500. In an embodiment, the autonomous driving system 2000 may be included in an automotive electronic system. The autonomous driving system 2000 may assist a driver such that driving of the vehicle is assisted, or may autonomously control driving of the vehicle without the intervention of the driver or with the intervention of the driver minimized.

The processor 2100 may control all operations of the autonomous driving system 2000. The sensor device 2200 may be configured to sense various operation information or various sensing information of the autonomous driving system 2000. Alternatively, the sensor device 2200 may be configured to capture the front, rear, or side view of the autonomous driving system 2000 (or the vehicle mounted with the autonomous driving system 2000).

The ADAS module 2300 may control operations (e.g., a steering operation, a braking operation, and an acceleration operation) of the autonomous driving system 2000 based on the sensing information from the sensor device 2200. In an embodiment, the sensor device 2200 may include the image device described with reference to FIGS. 1 to 18B. That is, the sensor device 2200 may generate long-exposure image data and short-exposure image data without an additional readout operation. In this case, it may be easy to identify an obstacle located in a specific range of the front, rear, or side of the vehicle, based on the short-exposure image data in which the motion blur is alleviated. Accordingly, the ADAS module 2300 may control the vehicle more accurately.

The user interface 2400 may provide information about the autonomous driving system 2000 to the driver or user or may receive information about the control of the autonomous driving system 2000 from the driver or user. For example, the user interface 2400 may be connected to an automotive control device such as a steering device, a braking device, an acceleration device, and a power device and may obtain various information provided from the driver through the automotive control device. Alternatively, the user interface 2400 may include a touch display panel that provides information about the autonomous driving system 2000 or the vehicle to the driver or receives information from the driver through the touch or operation of the driver.

The storage device 2500 may be configured to store information about the operation of the autonomous driving system 2000. In an embodiment, the storage device 2500 may be a data storage system for automated driving (DSSAD).

According to the present disclosure, an image device may generate mixed image data corresponding to a long-exposure time and a medium-exposure time. The image device may generate long-exposure image data corresponding to the long-exposure time based on the mixed image data. Also, the image device may generate short-exposure image data corresponding to the short-exposure time based on the mixed image data. That is, the image device may obtain long-exposure image data with a high resolution and short-exposure image data in which the motion blur is alleviated, based on the mixed image data generated through one readout operation. Accordingly, an image device with improved performance and an operation method of the image device are provided.

While aspects of embodiments have been particularly shown and described, it will be understood that various changes in form and details may be made therein without departing from the spirit and scope of the following claims.

What is claimed is:

1. An image device comprising:
an image sensor; and
an image signal processor,
wherein the image sensor comprises:
a plurality of pixels comprising first pixels configured to generate first analog signals corresponding to a first exposure time and second pixels configured to output second analog signals corresponding to a second exposure time shorter than the first exposure time;
an analog-to-digital converter configured to generate first image data by converting the first and second analog signals into a digital signal; and
a long-exposure image data generation circuit configured to generate second image data corresponding to the first exposure time by adjusting pixel values corresponding to the second pixels from among pixel values included in the first image data based on the first exposure time and the second exposure time, and
wherein the image signal processor comprises a short-exposure image data generation circuit configured to generate third image data corresponding to a third exposure time based on the second image data, the third exposure time corresponding to a difference between the first exposure time and the second exposure time.

2. The image device of claim 1, wherein the first exposure time corresponds to a time period from a first time point to a third time point,
wherein the second exposure time corresponds to a time period from a second time point to the third time point, the second time point being after the first time point and before the third time point, and
wherein the third exposure time corresponds to a time period from the first time point to the second time point.

3. The image device of claim 1, wherein a motion blur degree of the third image data is lower than a motion blur degree of the second image data.

4. The image device of claim 1, wherein the long-exposure image data generation circuit is further configured to generate the second image data by multiplying the pixel values of the first image data corresponding to the second pixels by an exposure time adjustment gain, the exposure time adjustment gain indicating a value obtained by dividing the first exposure time by the second exposure time.

5. The image device of claim 4, wherein the image sensor further comprises an exposure time register configured to store information about the first exposure time and information about the second exposure time received from the image signal processor.

6. The image device of claim 4, wherein the short-exposure image data generation circuit comprises:
a mixed image data extraction circuit configured to obtain the first image data based on the second image data; and
a short-exposure image data generator configured to generate the third image data based on the pixel values included in the first image data.

7. The image device of claim 6, wherein the mixed image data extraction circuit is further configured to obtain the first image data by dividing pixel values corresponding to the second pixels from among pixel values of the second image data by the exposure time adjustment gain.

8. The image device of claim 6, wherein the short-exposure image data generation circuit is further configured to calculate a third pixel value corresponding to a first position of the third image data based on a first pixel value corresponding to the first position of the first image data and a second pixel value of a second position around the first position, and
wherein the first pixel value corresponds to one of the first pixels, and the second pixel value corresponds to one of the second pixels.

9. The image device of claim 1, wherein the third image data do not include color information.

10. The image device of claim 1, wherein the image signal processor is configured to:
use the second image data for an image output through an external display device; and
use the third image data to obtain information of an external object.

11. The image device of claim 1, wherein the image signal processor further comprises a combined image data generation circuit configured to:
identify a blur region among regions in the second image data; and
generate fourth image data by replacing pixel values of the blur region with pixel values of a region of the third image data, which corresponds to the blur region.

12. An image device comprising:
an image sensor; and
an image signal processor,
wherein the image sensor comprises:
a plurality of pixels comprising first pixels configured to generate first analog signals corresponding to a first exposure time and second pixels configured to output second analog signals corresponding to a second exposure time shorter than the first exposure time; and
an analog-to-digital converter configured to generate first image data by converting the first and second analog signals into a digital signal, and
wherein the image signal processor comprises:
a long-exposure image data generation circuit configured to generate second image data corresponding to the first exposure time by adjusting pixel values corresponding to the second pixels from among pixel values included in the first image data based on the first exposure time and the second exposure time; and
a short-exposure image data generation circuit configured to generate third image data corresponding to a third exposure time based on pixel values corresponding to the first and second pixels from among the pixel values included in the first image data, the third exposure time corresponding to a difference between the first exposure time and the second exposure time.

13. The image device of claim 12, wherein the first exposure time corresponds to a time period from a first time point to a third time point,
wherein the second exposure time corresponds to a time period from a second time point to the third time point, the second time point being after the first time point and before the third time point, and
wherein the third exposure time corresponds to a time period from the first time point to the second time point.

14. The image device of claim 12, wherein the long-exposure image data generation circuit is further configured to generate the second image data by multiplying the pixel values of the first image data corresponding to the second pixels by an exposure time adjustment gain, the exposure time adjustment gain indicating a value obtained by dividing the first exposure time by the second exposure time.

15. The image device of claim 12, wherein the short-exposure image data generation circuit is further configured to calculate a third pixel value corresponding to a first position of the third image data based on a first pixel value corresponding to the first position of the first image data and a second pixel value of a second position around the first position, and
wherein the first pixel value corresponds to the first exposure time, and the second pixel value corresponds to the second exposure time.

16. The image device of claim 12, wherein the image signal processor further comprises a combined image data generation circuit configured to:
control, using the second image data, an image to be output through an external display device; and
obtain, using the third image data, information of an external object.

17. The image device of claim 12, wherein the image signal processor further comprises a combined image data generation circuit configured to:
identify a blur region among regions included in the second image data; and
generate fourth image data by replacing pixel values of the blur region with pixel values of a region of the third image data, which corresponds to the blur region.

18. The image device of claim 12, wherein a resolution of the third image data is lower than a resolution of the second image data.

19. A method of operating an image device which includes an image sensor, and an image signal processor, the method comprising:
generating, by the image sensor, first image data corresponding to a first exposure time and a second exposure time shorter than the first exposure time;
generating, by the image sensor, second image data by adjusting pixel values of the first image data based on an exposure time adjustment gain, the exposure time adjustment gain corresponding to a value obtained by dividing the first exposure time by the second exposure time;
transmitting the second image data to the image signal processor;
obtaining, by the image signal processor, the first image data based on the second image data; and
generating, by the image signal processor, third image data corresponding to a third exposure time shorter than the second exposure time based on the pixel values of the first image data.

20. The method of claim 19, wherein the third exposure time corresponds to a difference between the first exposure time and the second exposure time.
